(19) United States
(12) Patent Application Publication
(10) Pub. No.: US 2021/0209605 A1
(43) Pub. Date: Jul. 8, 2021

(54) METHOD AND SYSTEM FOR MULTI-TRIGGER PARAMETRIC DATA MANAGEMENT AND ASSOCIATED TRANSACTIONS

(71) Applicant: New Paradigm Group, LLC, Fort Lauderdale, FL (US)

(72) Inventors: Evan M. Glassman, Fort Lauderdale, FL (US); Bradley I. Meier, Golden Beach, FL (US)

(21) Appl. No.: 17/205,971

(22) Filed: Mar. 18, 2021

Related U.S. Application Data
(63) Continuation-in-part of application No. 16/438,329, filed on Jun. 11, 2019.
(60) Provisional application No. 62/683,489, filed on Jun. 11, 2018.

(51) Int. Cl. G06Q 20/40; G06Q 20/38; G01W 1/02

(52) U.S. Cl. CPC G06Q 20/4016; G01W 1/02; G06Q 20/389

(57) ABSTRACT

A method and system for multi-trigger parametric data management and associated transactions is provided. The parametric triggers can include measured wind speed occurring at predetermined geographic locations, calculated wind speed at a predetermined geographic locations, reported storm track and wind speed/category at a predetermined distance from a reference location and/or measured tide levels occurring at predetermined geographic locations. The multiple triggers are evaluated by the disclosed process to evaluate whether indicated threshold levels are exceeded such that conditions for full or fractional payout are achieved.

### CROSS-REFERENCE TO RELATED APPLICATIONS

This application claims priority under 35 U.S.C. § 120 as a continuation-in-part of U.S. patent application Ser. No. 16/438,329 filed on Jun. 11, 2019 and entitled “METHOD AND SYSTEM FOR MULTI-TRIGGER PARAMETRIC DATA MANAGEMENT AND ASSOCIATED TRANSACTION,” which claims the benefit of U.S. Provisional Application No. 62/683,489, filed on Jun. 11, 2018, entitled METHOD AND SYSTEM FOR MULTI-TRIGGER PARAMETRIC DATA MANAGEMENT AND ASSOCIATED TRANSACTIONS. U.S. patent application Ser. No. 16/438,329 and U.S. Provisional Application No. 62/683,489 are incorporated by reference in their entireties.

### TECHNICAL FIELD

The disclosed subject matter relates to methods and systems for measuring physical data such as wind speeds represented by multi-parametric data including, but not limited to, data relating to weather events such as tropical storms, cyclones and hurricanes and processes for evaluating such multi-parametric data to activate predetermined responses when if trigger conditions are achieved.

### BACKGROUND

Devices such as anemometers for the measurement of wind speeds are known, and devices for recording wind speed data are also known. Recorded wind speed data from such devices may be valuable for resolving insurance claims resulting from storm damage. However, during severe weather, or in the aftermath of severe storms, the recording of wind speeds may be interrupted and/or the recorded wind speed data may be lost due to physical damage, lightning strikes, water intrusion, power loss, looting, vandalism or other causes adversely affecting the wind speed measurement and recording devices and/or the media upon which the wind speed data is stored. A need therefore exists, for processes to collect and manage alternative or supplemental parametric data for evaluating the effects of severe weather.

Even when recorded wind speed data remains intact, following a severe storm it may be difficult to obtain access to the locations where the recorded wind speed data is stored. This can result in delays in obtaining recorded wind speed data, which in turn can delay the resolution of insurance claims resulting from storm damage. A need therefore exists, for methods, systems and media for managing parametric weather data that provide multiple triggers for evaluating the effects for a weather event, for evaluating the multi-parametric data to determine if any of multiple trigger conditions have occurred and/or to determine if payment under a contract is indicated.

Although evaluating the effect of a weather event using recorded wind speed data is preferred when available, in some circumstances a geographic area may include some areas of interest not currently measurable by anemometers or other wind speed measuring devices. In other circumstances, measured wind speed data may be lost due to equipment or communication failures that occur during the weather event. In yet other circumstances, a geographic area may be subject to damage by natural phenomenon other than wind, for example, by abnormal tides, storm surges and or flooding that may accompany a weather event. In these cases, data from multiple types or sources of weather-related data can be evaluated to provide a more reliable indicator of the effects of a weather event. A need therefore exists, for methods and system for conducting multi-trigger parametric data management and associated transactions.

US Patent Application Publication US 2017/0104648 A1 discloses a system for collecting and managing wind speed data via an external communications network comprising one or more wind stations. US Patent Application Publication US 2018/0075537 A1 discloses is a system and a method for a parametric risk transfer system based on automated location-dependent probabilistic tropical storm risk and storm impact forecast. US Patent Application Publication US 2017/0104648 A1 and US Patent Application Publication US 2018/0075537 are each hereby incorporated by reference in their entirety.

### SUMMARY

In one aspect thereof, a method for collecting and managing multi-trigger parametric data is provided. The method comprises establishing, prior to an event, a first trigger condition based on comparison of first parametric data to a first set of input values and establishing, prior to the event, a second trigger condition based on comparison of second parametric data to a second set of input values. The method further comprising receiving, after the event, first values for the first parametric data resulting from the event and second values for the second parametric data resulting from the event. The method further comprises comparing, after receiving the first values, the received first values to the first set of input values to determine if the first trigger conditions are met, and comparing, after receiving the second values, the received second values to the second set of input values to determine if the second trigger conditions are met. The method further comprising determining, for each of the first and second trigger conditions that are met, a respective payout fraction of a maximum amount associated with each met condition. The method further comprises comparing the payout fraction corresponding to the met first trigger conditions with the payout fraction corresponding to the met second trigger conditions and determining the highest of such payout fractions to be the maximum met payout fraction, wherein the payout amount is the maximum amount multiplied by the maximum met payout fraction.

In one embodiment, the first trigger condition is a storm track inside a predefined closed geographical area when the storm winds speed is greater or equal to a predefined input wind speed.

In another embodiment of the first trigger condition, the predefined closed geographical area is a circle of predetermined radius drawn around a predetermined latitude/longitude point.

In yet another embodiment of the first trigger condition, the predefined closed geographical area is a square of predetermined side length centered on a predetermined latitude/longitude point.

In still another embodiment of the first trigger condition, the predefined closed geographical area is a rectangle defined by four predetermined latitude/longitude points.

In a further embodiment of the first trigger condition, the predefined closed geographical area is a polygon defined by a plurality of predetermined latitude/longitude points.

In a yet further embodiment of the first trigger condition, if the storm track crosses the predefined geographical area, and there is a single announced storm track data point within the predefined geographical area, then the determined storm wind speed for the predefined geographical area is the wind speed for the single announced storm track data point.

In a still further embodiment of the first trigger condition, if the storm track crosses the predefined geographical area, and there is a plurality of announced storm track data points within the predefined geographical area, then the determined storm wind speed for the predefined geographical area is the highest wind speed for any of the plurality of announced storm track data points within the predefined geographical area.

In another embodiment of the first trigger condition, if the storm track crosses the predefined geographical area, but there are no announced storm track data points within the predefined geographical area, then the determined storm wind speed for the predefined geographical area is the greater of the wind speed of the announced storm track data point immediately preceding entry into the predefined geographical area and the wind speed of the announced storm track data point immediately following exit from the predefined geographical area.

In yet another embodiment of the first trigger condition, if the storm track crosses the predefined geographical area, but there are no announced storm track data points within the predefined geographical area, then the determined storm wind speed for the predefined geographical area is the average of the wind speed of the announced storm track data point immediately preceding entry into the predefined geographical area and the wind speed of the announced storm track data point immediately following exit from the predefined geographical area.

In still another embodiment, the second trigger condition is a storm wind speed value at a predefined geographical location that is greater or equal to a predefined input wind speed.

In a further embodiment of the second trigger condition, the predefined geographical point is defined by a latitude/longitude pair.

In a yet further embodiment of the second trigger condition, the storm wind speed value is a measured wind speed determined by an anemometer located at the predefined geographical point.

In a still further embodiment of the second trigger condition, the storm wind speed value is a calculated wind speed determined by a wind field calculation for the predefined geographical location.

In another embodiment of the second trigger condition, if an anemometer at a predefined geographical location provides usable data, the storm wind speed value is a measured wind speed determined by the anemometer located at the predefined geographical location, and if the anemometer does not provide usable data, the storm wind speed value is a calculated wind speed determined by a wind field calculation for the predefined geographical location.

In another aspect thereof, a method for collecting and managing multi-trigger parametric data is provided. The method comprises establishing a first trigger condition based on comparison of first parametric data to a first set of input values and establishing a second trigger condition based on comparison of second parametric data to a second set of input values. The first parametric data is measured, wherein the first parametric data includes direct wind speed measured at a one or more geographic location, and producing respective wind speed signals indicative of the respective direct wind speeds at each respective one or more geographic location, wherein the respective wind speed signals are one of electric signals and electronic signals. The respective wind speed signals are converted into respective direct wind speed data at each respective one or more geographic location, wherein the respective direct wind speed data is digital data. The respective direct wind speed data are transmitted at each respective one or more geographic location as digital data onto an external communications network. The one or more data server receives the respective direct wind speed data as digital data for the respective one or more geographic location from the external communication network. The received respective first parametric data including the direct wind speed data for the respective one or more geographic location is stored on the one or more data server. At the one or more data servers, the second parametric data is received, wherein the second parametric data includes at least one of a storm track including position data, time data and wind speed data, a calculated wind field for a geographic region, or a tide level for a geographic location. The received second parametric data is stored on the one or more data server. At the one or more data server, it is determined if first parametric data meets the first trigger condition, and if so, there is determined a first payout fraction corresponding to the first trigger condition. At the one or more data server, it is determined if the second parametric data meets the second trigger condition and if so, there is determined a second payout fraction corresponding to the second trigger condition. When it is determined that the one or more of first or second trigger conditions are met, the highest payout fraction is determined of the first or second payout fraction and an indication of the highest payout fraction is transmitted to the payout server on the external communications network. When it is determined that none of the first or second trigger conditions are met, an indication that no payout is triggered is transmitted to the payout server on the external communications network.

In one aspect thereof, a system for collecting and managing multi-trigger parametric data is provided. The system includes a payout server, a parametric data station, and a certification server. The payout server includes a payout communication interface, a payout server computing device, a payout server memory, and an accumulator. The payout communication interface is operatively coupled to an external communication network and configured to receive invoices. The payout server computing device is configured to process payments. The payout server memory is configured to store a first threshold and a first payout limits. The accumulator tracks a total amount of the received invoices; determines that a total amount of the received invoices is greater than the first threshold; in response to the total amount of the received invoices is determined to be greater than the first threshold, control the payout communication interface to provide the received invoices to the payout server computing device for processing payments; determines that a total for the processed payments is equal to the first payout limits; and in response to the total for the processed payments is determined to be equal to the first payout limits, control the payout communication interface to stop providing the received invoices to payout server computing device. The parametric data station includes a parametric data sensor, a station computing device, and a station communication interface. The parametric data sensor is configured to produce parametric data signal indicative of a measured parametric data value at a location of the parametric data station. The station computing device is operatively connected to the parametric data sensor and configured to receive the parametric data signal and produce parametric data corresponding to the parametric data signal. The station communication interface is operatively connected to the station computing device and the external communication network, and receives the parametric data from the station computing device and transmits the parametric data to the external communication network. The certification server includes a certification communication interface, a certification server memory, and a certification server computing device. The certification communication interface is operatively coupled to the external communication network and is configured to receive the parametric data from the parametric data station and transmits a signal for adjusting the first threshold to the payout communication interface. The certification server memory stores parametric thresholds. The certification server computing device determines that the received parametric data exceeds a parametric threshold; and in response to the received parametric data exceeding the parametric threshold, generates the signal to cause a reduction of the first threshold.

In one embodiment, an amount of the first threshold is equal to an amount of the first payout limits.

In another embodiment, the payout server memory includes an amount for the reduction prior to receiving the signal from the certification server.

In yet another embodiment, the first threshold is reduced to zero.

In still another embodiment, a second threshold is equal to the first payout limits added to the first threshold before the reduction. The accumulator determines that the total amount of the received invoices is greater than the second threshold; and, in response to the total amount of the received invoices is determined to be greater than the second threshold, controls the payout communication interface to provide the received invoices to the payout server computing device for processing payment.

In a further embodiment, the payout communication interface receives an externally-processed invoice. The accumulator, after the total amount of received invoices has exceed the first threshold, reduces the second threshold by an amount of the externally-processed invoice.

In a yet further embodiment, when an amount of the externally-processed invoice reduces the second threshold below a value of the first payout limits, the accumulator maintains providing payments to the payout server computing device when the total amount of the received invoices is equal to or greater than the first payout limits.

In a still further embodiment wherein, to determine that the received parametric data exceeds a parametric threshold and to generate the signal to cause a reduction of the first threshold, the certification server computing device determines that a first parametric data exceeds a first parametric threshold; determines that a second parametric data exceeds a second parametric threshold; and in response to the first parametric data exceeding the first parametric threshold and the second parametric data exceeding the second parametric threshold, generates the signal to cause the reduction of the first threshold.

In another embodiment, the first parametric data is a different parametric type than the second parametric data.

In yet another embodiment, the first parametric data and the second parametric data are both a parametric data type and are captured from different parametric sensors.

In another aspect thereof, a system for collecting and managing multi-trigger parametric data is provided. The system includes a payout server and a certification server. The payout server includes a payout communication interface, a payout server computing device, a payout server memory, and an accumulator. The payout communication interface is operatively coupled to an external communication network and configured to receive invoices. The payout server computing device is configured to process payments. The payout server memory is configured to store a first threshold and a first payout limit. The accumulator tracks a total amount of the received invoices; determines that a total amount of the received invoices is greater than the first threshold; in response to the total amount of the received invoices is determined to be greater than the first threshold, controls the payout communication interface to provide the received invoices to the payout server computing device for processing payments; determines that a total for the processed payments is equal to the first payout limits; and in response to the total for the processed payments is determined to be equal to the first payout limits, controls the payout communication interface to stop providing the received invoices to payout server computing device. The certification server includes a certification communication interface, a certification server memory, and a certification server computing device. The certification communication interface is operatively coupled to the external communication network and configured to receive the parametric data from the parametric data station and transmit a signal for adjusting the first threshold to the payout communication interface. The certification server memory stores parametric thresholds. The certification server computing device determines that the received parametric data exceeds a parametric threshold; and in response to the received parametric data exceeding the parametric threshold, generates the signal to cause a reduction of the first threshold.

Other technical features may be readily apparent to one skilled in the art from the following figures, descriptions, and claims.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a wind station system for managing wind speed data in accordance with some embodiments of the disclosed subject matter;

FIG. 1a is an enlarged view of the anemometer used in some embodiments of the wind station system of FIG. 1;

FIGS. 2a-2d show an overview of a tide gauge network in accordance with some embodiments, including examples of a tide station for managing water level data in accordance with additional embodiments, along with an exemplary tide gauge sensor, exemplary tide level data and exemplary geographic coverage map data, wherein:

FIG. 2a shows a tide station system;

FIG. 2b shows a close-up view of a tide sensor (or water level sensor);

FIG. 2c shows an example of a tide level system geographic coverage map including tide stations systems and/or tide sensors distributed at various geographic locations within an exemplary geographic area; and

FIG. 2d shows exemplary tide data collected from tide stations systems including predicted tide, observed water levels and water level variance or storm surge levels;

FIG. 3 shows an example of hardware for managing multi-trigger parametric data that can be used in accordance with some embodiments of the disclosed subject matter;

FIG. 4 shows an example of hardware implemented as a computing device in accordance with some embodiments of the disclosed subject matter;

FIG. 4a shows an example payout server in accordance with embodiments of the present disclosure;

FIGS. 5a, 5b and 5c show an exemplary process for managing multi-trigger parametric data and generating associated transaction data in accordance with some embodiments of the disclosed subject matter;

FIG. 6 an exemplary storm track map for a tropical storm including underlying geographic features, storm path location data and time data, and wind speed and direction data;

FIG. 7 shows an exemplary set of parametric wind triggers for a hurricane for use in a parametric wind triggered product for hurricanes in accordance with another embodiment;

FIG. 8 shows a calculated (i.e., modeled) wind footprint chart for an exemplary tropical storm (i.e., Hurricane Irma, 2017) at a first specified time in accordance with one type of parametric data used in embodiments disclosed herein, including underlying geographic feature data, storm center position data, graduated wind speed contour data, wind direction data, hurricane force wind contour line data and tropical storm force wind contour line data;

FIG. 9 shows a coverage territory map including calculated (i.e., modeled) wind footprint chart for the exemplary tropical storm of FIG. 8 at a second specified time;

FIG. 10 shows an exemplary coverage territory map including underlying geographic feature data, C-I-C calculation location data (i.e. “proxy station” in FIG.), C-I-C covered radius data, and storm center time/position data;

FIG. 11 shows an exemplary triggering mechanisms map including underlying geographic feature data, wherein the predefined geographical location is a circle of predefined radius around a predefined geographical point, i.e., Cat-in-a-Circle (“C-I-C”), showing calculation location data, C-I-C covered radius data, wind speed calculation location (anemometer) data, tide gauge calculation location data and storm track parametric data including multiple announced storm track data points, with respective time, position and wind speed data;

FIG. 12 shows an exposure map including underlying geographic feature data illustrating another exemplary triggering mechanism, wherein the predefined geographical location is a polygon defined by a plurality of latitude/longitude points, i.e., Cat-in-a-Box (“C-I-B”), showing a predefined geographical area (i.e., C-I-B location data) and storm track parametric data including multiple announced storm track data points, with respective time, position and wind speed data;

FIG. 13 shows a first exemplary premium indication based on multi-trigger (e.g., binary) parametric data management and transactions in accordance with embodiments of the disclosed subject matter including C-I-C calculation location inputs, C-I-C covered radius inputs, C-I-C category (CAT) magnitude threshold level inputs (1 . . . N₁), wind calculation location inputs (1 . . . N₂), wind threshold inputs (1 . . . N₃) and payout level inputs;

FIG. 14 shows a second exemplary premium indication based on multi-trigger (e.g., binary) parametric data management and transactions in accordance with embodiments of the disclosed subject matter including C-I-C calculation location inputs, C-I-C covered radius inputs, C-I-C category (CAT) magnitude threshold level inputs (1 . . . N₁), wind calculation location inputs (1 . . . N₂), wind threshold inputs (1 . . . N₃) and payout level inputs;

FIG. 15 shows an example of a seismic station system for managing seismic data in accordance with another aspect of the disclosed subject matter;

FIG. 16 shows an example of hardware for managing seismic data that can be used in accordance with some embodiments of the disclosed subject matter;

FIG. 17 shows an example of a process for managing seismic data in accordance with some embodiments of the disclosed subject matter;

FIG. 18 shows an example of a process for managing seismic data including triggering seismic event payouts based on seismic data in accordance with some embodiments of the disclosed subject matter; and

FIG. 19 shows an example of hardware for managing both wind speed data and seismic data that can be used in accordance with some embodiments of the disclosed subject matter.

FIG. 20 shows an exemplary coverage chart in accordance with this disclosure;

FIG. 21 shows an exemplary drop-down endorsement in accordance with this disclosure; and

FIG. 22 shows an exemplary order of operations for responding to an event in accordance with this disclosure.

### DETAILED DESCRIPTION

In accordance with various embodiments of the disclosed subject matter, mechanisms (which can include methods, systems, and media) for managing wind speed data are described herein.

In one aspect, a method for collecting and managing multi-trigger parametric data comprises establishing, prior to an event, a first trigger condition based on comparison of first parametric data to a first set of input values and establishing, prior to the event, a second trigger condition based on comparison of second parametric data to a second set of input values. The event associated with the method is typically a weather-related event including, but not limited to, a hurricane, a tropical storm, a typhoon, a monsoon, a tidal wave, a surge tide, a flood, a tornado or a hailstorm. However, the multi-trigger parametric data method is applicable to other types of future events including, but not limited to an earthquake, a volcano, a landslides or a forest fire.

The exact nature of the first and second trigger conditions is dependent upon the characteristics of the subject event, and in particular, to the anticipated damage-inflicting characteristics of the event. For example, if the subject event is a wind event such as a hurricane or tropical storm, the anticipated damage-inflicting characteristics are primarily related to storm path and maximum sustained wind speed but may also be related to secondary damage mechanisms such as tidal surges, rainfall and/or flooding. In another example, if the subject event is a seismic event such as an earthquake, the anticipated damage-inflicting characteristics are primarily related to seismic magnitude and event duration but may also be related to secondary damage mechanisms such as landslides and/or fires. The first and second trigger conditions are chosen to respond, respectively, to first and second parametric data.

The first and second trigger conditions, and thus the associated first and second parametric data may be completely or partially independent from one another. In one example of a hurricane event, the first trigger conditions and the first parametric data can relate to wind speed and duration values at a first geographical location and the and second trigger conditions and the second parametric data can relate to storm surge levels at a second geographical location. In another example of a hurricane event, the first trigger conditions/parametric data can relate to wind speed and duration values at a first geographical location and the and second trigger conditions/parametric data can relate to storm surge levels at the same first geographical location. In still another example of a hurricane event, the first trigger conditions/parametric data can relate to wind speed and duration values measured by an anemometer located at a first geographical location and the and second trigger conditions/parametric data can relate to announced (i.e., reported or officially acknowledged) storm track positions and wind speeds issued by a third-party. In any event, at least some elements of the first trigger conditions/parametric data must be different from the second trigger conditions/parametric data. In some embodiments, the first and/or second parametric data can have a primary data set and a secondary data set, wherein values of the respective primary data set are normally used by the method for the respective parametric data values, but when values of the primary set are not available, the values of the respective secondary data set are used by the method.

The storm track can be, but is not limited to, a continuous track defined by a series of consecutive announced storm data points such as those produced/released by the National Hurricane Center (NHC) of NOAA. Each storm data point can include, e.g., a time, a geographical location (e.g., latitude/longitude pair) and a wind speed at that time/location. The wind speed can be provided in either physical units (e.g., miles per hour) or in categorical units, also known as “Category” or “Cat” units (e.g., Cat 1-5 of the Saffir-Simpson Hurricane scale, also known as the “Cat scale”). For example, the predefined geographical location can be a circle of predetermined radius drawn around a predetermined latitude/longitude point (sometimes known as “Cat-in-a-circle” if using Cat scale for wind speed). In another example, the predefined closed geographical area can be a square of predetermined side length centered on a predetermined latitude/longitude point (sometimes known as “Cat-in-a-box” if using the Cat scale). In still another example, the predefined closed geographical area can be a rectangle defined by four predetermined latitude/longitude points (also known as “Cat-in-a-box” if using the Cat scale). In a further example, the predefined closed geographical area can be any polygon defined by a plurality of predetermined latitude/longitude points.

Since the storm track can comprise a sequence of discrete announced storm data points, in different events where the storm track traverses the predefined closed geographical area, there may or may not be any announced storm data points within the boundaries of the closed geographical area. The trigger conditions can therefore be adapted to reflect the desired calculation mode for such conditions. For example, if the storm track crosses the predefined geographical area, and there is a single announced storm track data point within the predefined geographical area, then the determined storm wind speed for the predefined geographical area can be the wind speed for the single announced storm track data point, but if the storm track crosses the predefined geographical area, and there are a plurality of announced storm track data points within the predefined geographical area, then the determined storm wind speed for the predefined geographical area can be the highest wind speed for any of the plurality of announced storm track data points within the predefined geographical area. Further, in some examples, if the storm track crosses the predefined geographical area, but there are no announced storm track data points within the predefined geographical area, then the determined storm wind speed for the predefined geographical area can be the greater of the wind speed of the announced storm track data point immediately preceding entry into the predefined geographical area and the wind speed of the announced storm track data point immediately following exit from the predefined geographical area. Alternatively, if the storm track crosses the predefined geographical area, but there are no announced storm track data points within the predefined geographical area, then the determined storm wind speed for the predefined geographical area can be the average of the wind speed of the announced storm track data point immediately preceding entry into the predefined geographical area and the wind speed of the announced storm track data point immediately following exit from the predefined geographical area.

The previous examples of first trigger conditions are not limiting, for example, the first trigger condition could be any conditions based on comparison of first input values provided prior to the event and first parametric data values based on the event. For example, tropical storm events can have a first trigger condition based on first parametric data including surge tide levels, rainfall and/or flooding instead of wind conditions. In other types of events, the first trigger condition can be appropriately selected to correspond to an appropriate parametric data set.

In another embodiment, the second trigger condition is a storm wind speed value at a predefined geographical location that is greater or equal to a predefined input wind speed. The predefined geographical location for the second trigger condition can be a point defined by a latitude/longitude pair. The predefined geographical location is sometimes referred to as a “calculation point.” In one example of the second trigger condition, the storm wind speed value is a measured wind speed determined by an anemometer located at the predefined geographical location. In another example of the second trigger condition, the storm wind speed value is a calculated wind speed determined by a wind field calculation for the predefined geographical location. The wind field calculation can be a parametric data set provided by the user or by a third-party including, but not limited to, RMS® data sets that can be obtained from servers at Risk Management Solutions, Inc. In yet another example, if an anemometer at a predefined geographical location provides usable data, the storm wind speed value is a measured wind speed determined by the anemometer located at the predefined geographical location, and if the anemometer does not provide usable data, the storm wind speed value is a calculated wind speed determined by a wind field calculation data set for the predefined geographical location.

The previous examples of second trigger conditions are not limiting, for example, the second trigger condition could be any conditions based on comparison of second input values provided prior to the event and second parametric data values based on the event, provided, however, that the second parametric data is at least partially independent of the first parametric data.

After the occurrence of a subject event, the values of the first parametric data and the values of the second parametric data must be obtained determine if the first trigger conditions and/or the second trigger conditions are met. Each of the first and second trigger conditions may define, respectively, a plurality of levels of meeting the respective trigger condition. For example, if the first trigger condition is based on a wind speed category (“CAT”) level, a first level of the first trigger condition can be met by a Cat 1 storm, a second level of the first trigger condition can be met by a Cat 2 storm, a third level of the first trigger level can be met by a Cat 3 storm, etc. The method further comprising determining, for each of the first and second trigger conditions that are met, a respective payout fraction of a maximum amount associated with each met condition. For the previous example, a first payout fraction for meeting the first level of the first trigger condition can be 25% of maximum amount, a second payout fraction for meeting the second level of the first trigger condition can 50% of the maximum amount, a third payout fraction for meeting the third level of the first trigger level can be 100% of the maximum amount. A substantially similar set of steps is run, respectively, for the second trigger conditions, including multiple levels and payout fractions, if applicable. It will be understood that the methods disclosed herein are not limited to only first and second trigger conditions but may further comprise additional trigger conditions based on additional input values and additional parametric data, levels and payout fractions.

After determining the respective payout fractions for each of the trigger conditions sets, the highest of such payout fractions is selected to be the maximum met payout fraction, and the payout amount is determined as the maximum amount multiplied by the maximum met payout fraction.

For purposes of explanation and illustration, some of the exemplary systems and methods described herein include only first and second trigger conditions based on two corresponding sets of parametric data. However, these systems and methods described herein are not limited to only two trigger conditions nor to only two corresponding sets of parametric data. Rather, the systems and methods described herein allow the consideration of essentially an unlimited number of trigger conditions and corresponding sets of parametric data. For one example, a first trigger condition can be a “Cat-in-a-Circle” or “Cat-in-a-Box” type condition covering a large predefined geographical area with the parametric data being reported storm track data, and ten additional trigger conditions can be set for sustained wind speed values at ten different anemometer locations (e.g., calculation locations) defined by specific latitude/longitude pairs, thus providing eleven independent trigger conditions driven by eleven sets of corresponding parametric data. After an event, each of the eleven trigger conditions can be evaluated, and the largest payout fraction corresponding to any of the met trigger conditions can be used to determine the payout.

For an even larger example, a first trigger condition can be a “Cat-in-a-Circle” based on a first, circular-shaped geographic location defined by a center location and a radius, with the corresponding parametric data set being reported NHC storm track data. A second trigger condition can be a “Cat-in-a-Box” based on a second, irregular polygonal-shaped geographic location defined by a set of boundary points (e.g., specific latitude/longitude pairs at the vertices of the polygon) with the corresponding parametric data set also being reported NHC storm track data. Third through twelfth trigger conditions can be set for sustained wind speed values at ten different anemometer locations (defined by specific latitude/longitude pairs). Thirteenth through twenty-second trigger conditions can be set for tide level values at ten different tide gauge locations (also defined by specific latitude/longitude pairs), thus providing twenty-two independent trigger conditions driven by corresponding parametric data. After an event, each of the trigger conditions can be evaluated against associated parametric data, and a largest payout fraction corresponding to any of the met trigger conditions can be used to determine the payout. In some cases where the trigger conditions are defined by different input values, the same set of parametric data can be used to evaluate more than one of the trigger conditions, for example, when the parametric data set is NHC reported storm track data, two or more trigger conditions having different geographical boundaries can be independently evaluated using the same parametric data.

When large numbers of trigger conditions are set for an event, thus involving management of a very large number of input values sets and management and evaluation of very large quantities of parametric data corresponding to trigger condition, the systems and methods described herein can be executed in an automated fashion as provided herein to provide fast and accurate determination of payout amounts, which are essential when responding to large-scale events such as hurricanes and other weather events or damaging natural phenomena.

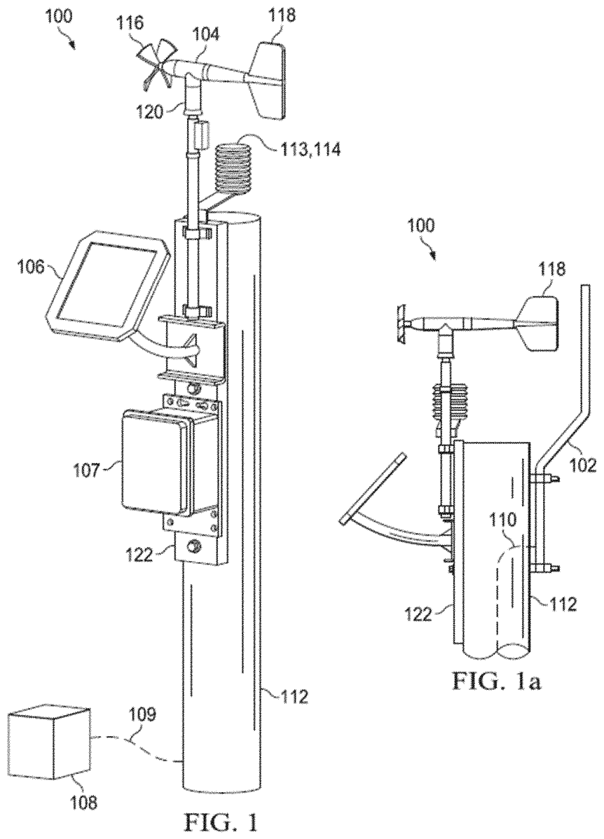

Referring now FIGS. 1 and 1a, there is illustrated an example of a wind station system 100 for collecting and managing wind speed data in accordance with some embodiments of the disclosed subject matter. In some embodiments, the wind station system 100 is disposed at a particular geographic location and manages wind speed data for winds occurring at the particular geographic location. As shown, in some embodiments, the wind system can include a lightning terminal 102 (i.e., lightning rod), a wind speed sensor 104 (such as an anemometer), a solar panel 106, a battery box 107, a computing device 108, a ground wire 110 and a pole 112. In some embodiments, the computing device 108 can be located on the pole 112, whereas in other embodiments, the computing device can be located remotely from the pole (e.g., in a secure location) and connected to the wind speed sensor 104 via a data link 109. In some embodiments the data link 109 can be a wired connection (e.g., electrical wires, optical fibers, etc.) and in other embodiments the data link can be a wireless connection (e.g., Wi-Fi, cellular radio, radio etc.). The wind system can further include a temperature gauge/thermometer 113 and/or a humidity gauge 114. In some embodiments, all of these elements can be disposed at the particular geographic location, whereas in other embodiments, some of the elements may be disposed at different geographic locations. It should be understood that although only one of each of these elements is shown in FIG. 1, more than one of each of these elements can be used in some embodiments.

In some embodiments, any lightning terminal 102 suitable for conducting the electric charge of a lightning strike away from other components can be used. For example, the lightning terminal 102 can comprise an electrically conductible rod, an electrically conductible wire (such as ground wire 110), and/or any other electrically conductible part or assembly of parts. In the illustrated embodiment, the lightning terminal 102 includes ground wire 110 made of copper that is routed internally to the support pole 112.

In some embodiments, the lightning terminal 102 can be connected to the ground wire 110 such that in the event of a lightning strike, the electric charge will be grounded to the earth. In some embodiments, any suitable ground wire 110 can be used. For example, the ground wire 110 can be a copper wire, a shielded wire, an insulated wire and/or any other type of wire suitable for grounding an electric charge.

In some embodiments, the ground wire 110 can be inserted at any suitable depth into the earth. For example, a ground wire 110 can be inserted into the earth to a depth of 20 feet below the ground level (i.e., surface) at the location.

Referring still to FIGS. 1 and 1a, in some embodiments, any wind speed sensor 104 suitable for measuring wind speeds can be used. For example, referring now specifically to FIG. 1A, in the illustrated embodiment the wind speed sensor 104 may include a propeller 116. In some such embodiments, the wind speed sensor 104 can produce an electrical signal when the propeller 116 is rotated by wind. In a more particular example, the propeller 116 can produce an AC sine wave electrical signal. In another more particular example, the propeller 116 can be configured to produce an electrical signal directly proportional to wind speed. The wind speed sensor 104 may further include a tail assembly 118 and a swivel bearing 120 rotatably connected to the pole 112, whereby the action of the wind on the tail assembly causes the anemometer to rotate horizontally on the swivel bearing to keep the propeller facing into the wind. In some embodiments, the wind speed sensor 104 can be implemented without a propeller 116 using other moving apparatus, for example, moving cups, vanes, rotors and/or with non-moving apparatus, for example, a pitot tube assembly, to measure the wind speed. In other embodiments, the wind speed sensor 104 can produce electrical signals (e.g., analog voltage, current, frequency or phase signals) or electronic signals (e.g., digital electric signals) proportional to the measured wind speed and/or indicative of the measured wind speed at the anemometer's geographic location.

In some embodiments of the wind station system 100, each component of the measuring system (e.g., solar panel 106, wind speed sensor 104 and battery box 107) is attached to the aluminum channel with four ⅜ inch stainless steel bolts. In some embodiments, the solar panel 106 and mount can be of the type sold by Sol, Inc. of Palm City, Fla., USA. In some embodiments of the wind station system 100, a mounting bracket 122 can be used to attach components to the pole 112. In one embodiment, the mounting bracket 122 is a fabricated aluminum channel bracket ¼ inch thick having 7.5 inch flange×1.75 inch legs×43 inches long.

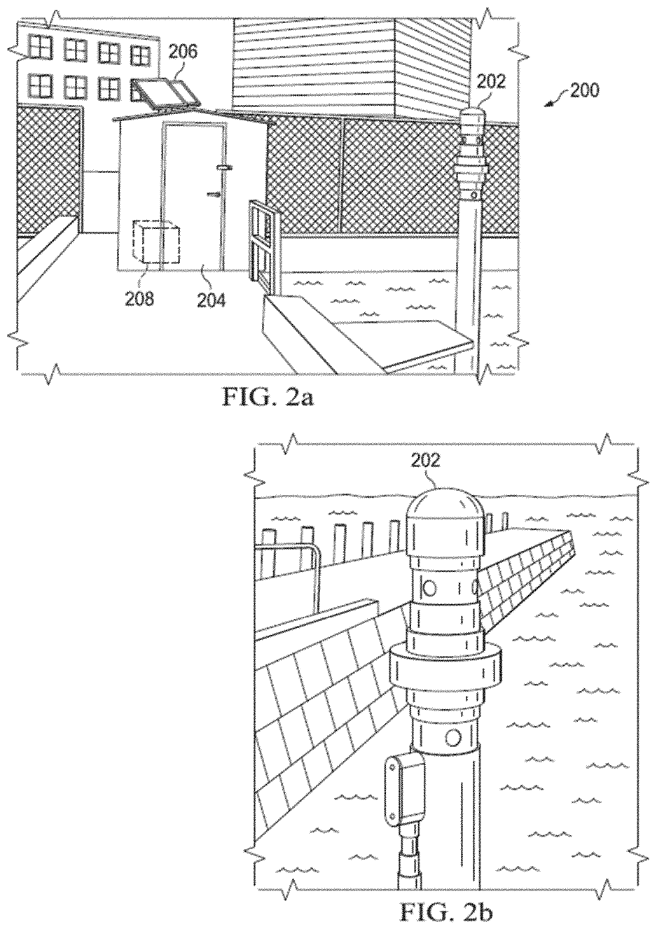

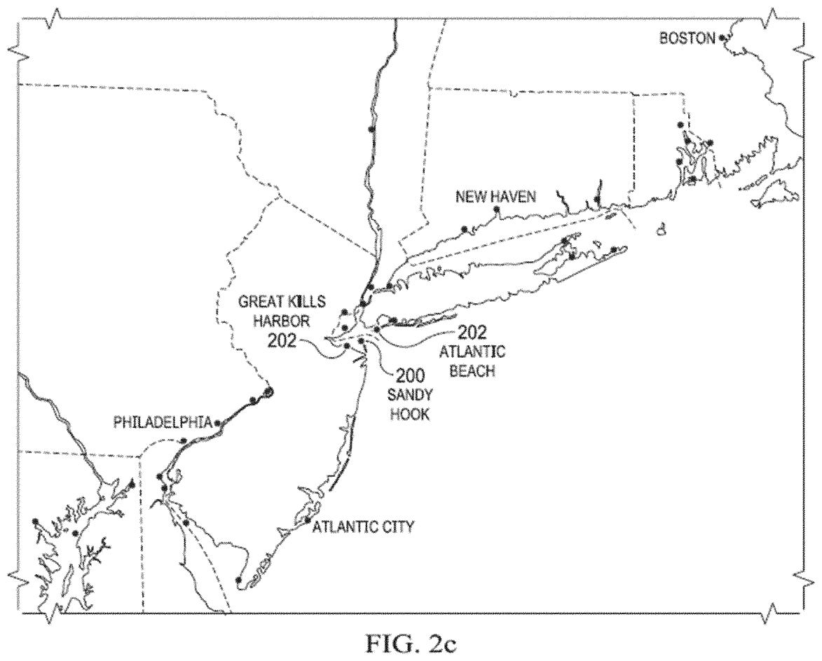

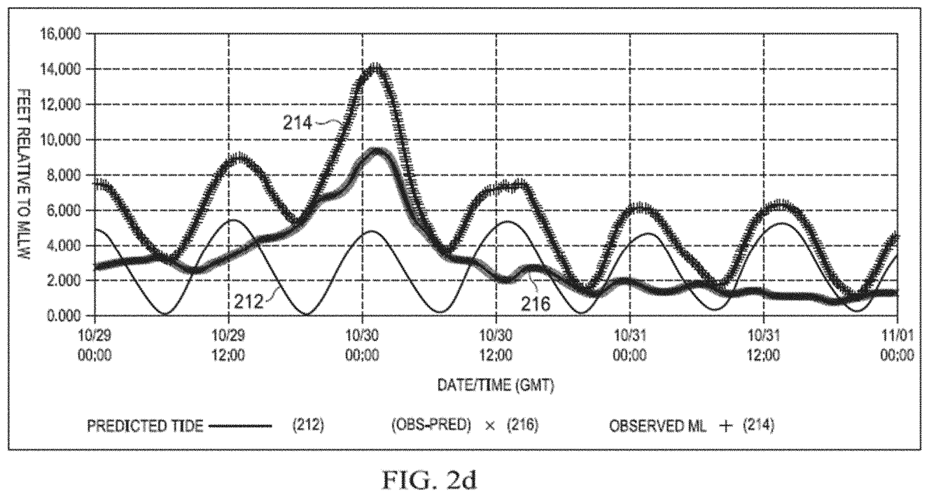

Referring now to FIGS. 2a-2d, there is illustrated an example of a tide station system 200 and a tide sensor 202 for collecting and managing water level data (also referred to as tide level data), and also exemplary water level data 210 in accordance with some embodiments of the disclosed subject matter. In some embodiments, the tide station system 200 is disposed at a particular geographic location (see map in FIG. 2c) and manages tide data and/or water level data only for water levels occurring at the particular geographic location. In other some embodiments, one tide station system 200 disposed at a particular geographic location can manages tide data and/or water level data for water levels occurring a plurality of geographic locations remote from the particular geographic location, e.g., one or more remote locations having tide sensors 202. As shown in FIG. 2a, in some embodiments, the tide station system 200 can include at least one water level sensor unit (such as tide sensors 202) (FIG. 2b), an instrument shed 204, a solar panel 206 and a computing device 208 (shown in phantom; typically located with the shed). In some embodiments, all of these elements can be disposed at the particular geographic location, whereas in other embodiments, some of the elements may be disposed at different geographic locations. It should be understood that although only one of each of these elements is shown in FIG. 2, more than one of each of these elements can be used in some embodiments.

Referring to FIG. 2d, exemplary water level data/tide data 210 for a particular geographic area can be produced comprising plots of water level, e.g., measured in feet relative to MLLW (Mean Lower Low Water), for a predicted tide level (line 212 in FIG. 2d), i.e., astronomical tide, and for an observed water level (line 214 in FIG. 2d) over a selected time period. In some embodiments, the predicted/astronomical values for the tide level 212 can come from so-called tide tables or from tide models. In some embodiments, the observed values of the water level 214 can come from tide station systems 200 and/or water level sensors 202. The difference between the observed water level 214 and predicted tide level 212 (i.e., values of line 214 minus corresponding values of line 212) can be considered the storm surge value (line 216 in FIG. 2d), since the storm surge is defined as an abnormal rise of water generated by a storm, over and above the predicted astronomical tides.

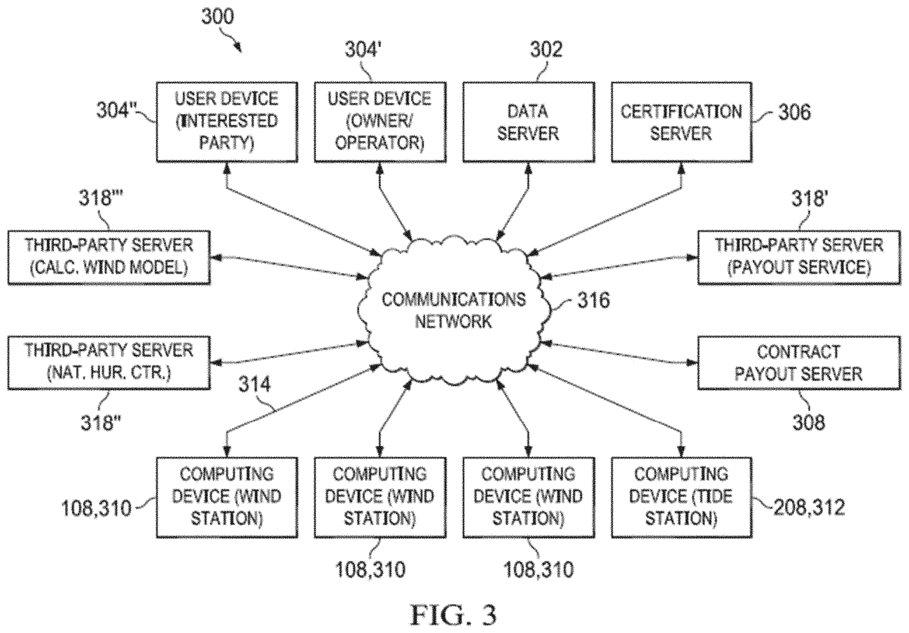

Referring now to FIG. 3, there is illustrated one example of system hardware 300 for managing multi-trigger parametric data that can be used in accordance with some embodiments of the disclosed subject matter. As illustrated, the system hardware 300 can include one or more: data servers 302, user devices 304, certification servers 306, contract payout servers 308, wind stations 310 with computing devices 108 and, optionally, tidal stations 312 with computing devices 208.

In some embodiments, the wind station 310 can be any suitable wind station configured with a wind measuring device and a computing device. For example, as shown in FIG. 1, the wind station can be the wind station system 100 with wind speed sensor 104 disposed at a particular geographic location.

In some embodiments, the tide station 312 can be any suitable tide station configured with a water level measuring device and a computing device. For example, as shown in FIG. 2a, the tide station 312 can be the tide station system 200 with tide sensor (i.e., water level sensor) 202 disposed at a particular geographic location.

In some embodiments, the data server 302 can be any suitable server for storing data and/or delivering the data to a user device 304. In some embodiments, the data stored by the data server 302 and/or delivered to the user device 304 can be implemented as digital data in any digital data format. For example, the data server 302 can be a server that delivers data to a user device 304 and/or receives data from a wind station 310 via a communication network 316. In some embodiments, the data server 302 can include a server computing device (e.g., hardware 400) having a server communication interface operatively connected to the communication network 316 to receive respective wind speed data from one or more wind stations 310 and operatively connected to the server computing device to provide the received respective wind speed data to the server computing device and a server memory disposed at the respective data server location and operatively connected to the server computing device for storing the received respective wind speed data. In some embodiments, the data server 302 can include a server computing device 400 having a server communication interface operatively connected to the communication network 316 to receive respective tide/water level data (e.g., data 210) from one or more tide stations 312 and operatively connected to the server computing device to provide the received respective tide/water level data to the server computing device and a server memory disposed at the respective data server location and operatively connected to the server computing device for storing the received respective tide/water level data. Data stored and/or delivered by the data server 302 can be any suitable data, such as wind speed data, wind direction data, tide data, water level data, historical weather data, historical tide data, historical water level data, contract data, contract payout data and/or any other suitable data. Data can be recorded and uploaded to the data server 302 by any suitable entity (e.g., a wind station computing device or a tide station computing device). In some embodiments, the data server 302 can be disposed at a geographic location that is remote from (i.e., geographically distant from) the wind station 310, wind station system 100, tide station 312 or tide station system 200, whereas in other embodiments, the data server can be disposed at the same geographic location as the wind station, wind station system, tide station or tide station system. In some embodiments having more than one wind station system 100 and/or tide station system 200, each respective wind station system 100 or tide station system 200 can be disposed at a different respective wind or tide station location, and the data server 302 can be disposed at a data server location that is remote from at least one of the respective wind or tide station locations. In some embodiments having more than one wind station system 100 or tide station system 200 and more than one data server 302, each respective wind station system or tide station system can be disposed at a different respective wind station or tide station location, and each respective data server can be disposed at a different respective data server location, wherein the respective wind or tide station locations and data server locations are all geographically remote from one another. In some other embodiments, the data server 302 can be omitted.

The communication network 316 can be any suitable combination of one or more wired and/or wireless networks in some embodiments. For example, the communication network 316 can include anyone or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. The user device 304 can be connected by one or more communication links 314 to the communication network 316, which can be linked via one or more communications links to the data server 302, and/or wind stations 310, and/or tide station 312. The communication links 314 can be any communications links suitable for communicating data among the user device 304, data server 302, wind stations 310 and/or tide stations 312, such as network links, dial-up links, wireless links, hard-wired links, any other suitable communications links, or any suitable combination of such links. In some embodiments, the data communicated across the communication network 316 and/or communication links 314 can be implemented as digital data in any digital data format.

The user device 304 can include any one or more user devices suitable for requesting data, searching for data, viewing data, retransmitting data, manipulating data, receiving a user input and/or any other suitable functions. For example, in some embodiments, the user device 304 can be implemented as a mobile device, such as a mobile phone, a tablet computer, a laptop computer and/or any other suitable mobile device. As another example, in some embodiments, the user device 304 can be implemented as a non-mobile device such as a desktop computer and/or any other suitable non-mobile device. In some embodiments, the user device 304 can be disposed at a geographic location that is remote from (i.e., geographically distant from) the wind station system 100, the tide station system 200 and/or the data server 302, whereas in other embodiments, the user device can be disposed at the same geographic location as the wind station system, the tide station system and/or the data server. Some embodiments can have multiple user devices 304, wherein the owner/operator of the system controls or operates one user device 304′ and other interested parties (e.g., customers, vendors, contractors, etc.) control or operate another of the user devices 304″.

In some embodiments, the contract payout server 308 can be any suitable server for causing a contract to be paid out based on wind speed data and/or tide or water level data. For example, the contract payout server 308 can be a server that receives wind speed data and or tide data from a data server 302 via a communication network 316, and/or determines whether a contract should be paid out based on wind speed data and/or tide data and/or causes a third-party server 318 (e.g., third-party payout service 318′) to payout a contract by communicating with the third-party server 318 over the communication network. The storage of the wind speed data, tide data and other information, programs, data and/or other suitable information on the contract payout server 308 can be implemented as digital data in any digital data format. In some embodiments, the payout server 308 can include a payout server computing device (e.g., hardware 400) having a payout server communication interface operatively connected to the communication network 316 to receive respective certification reports from one or more certification servers 306 and operatively connected to the payout server computing device to provide the received respective certification reports to the payout server computing device, and/or a payout server memory operatively connected to the payout server computing device for storing the received respective certification reports. In some embodiments, the payout server computing device of the contract payout server 308 can determine if a received respective certification report satisfied the terms of an associated contract, and if so, the payout server can trigger a payout at another location by communicating over the communication network 316 In some embodiments, the contract payout server 308 can be disposed at a geographic location that is remote from (i.e., geographically distant from) the wind station 310, wind station system 100, tide station 312, tide station system 200, the data server 302 and/or the user device 304, whereas in other embodiments, the contract payout server can be disposed at the same geographic location as the wind or tide station, wind or tide station system, the data server and/or the user device.

In some embodiments, third-party servers 318 can be any suitable server for providing data including parametric data such as measured wind speed data and measured tide data. Third-party servers 318 can also supply other forms of parametric data including, but not limited to, real time or historical calculated (i.e., modeled) wind field data, historical wind data, historical tide data, historical water level data, real time or historical storm tracks. In some embodiments, one third-party server 318″ can be any server at the National Hurricane Center operated by NOAA. In some embodiments, one third-party server 318′″ can be any server providing RMS® North Atlantic Hurricane Models from Risk Management Solutions, Inc. of Newark Calif.

In some embodiments, the certification server 306 can be any suitable server for certifying wind speed data, tide data or other parametric data. For example, the certification server 306 can be a server that receives wind speed data, tide data and/or water level data from a data server 302 via a communication network 316, and/or stores historical wind speed data, tide data and/or water level data and/or determines whether wind speed data, tide data and/or water level data is accurate. The storage of the wind speed data, tide data, and other information, programs, data and/or other suitable information on the certification server 306 can be implemented as digital data in any digital data format. In some embodiments, the certification server 306 can include a certification server computing device (e.g., hardware 400) having a certification server communication interface operatively connected to the communication network 316 to receive respective wind speed data, tide data and/or water level data from one or more data servers 302 and operatively connected to the certification server computing device to provide the received respective wind speed data, tide data and/or water level data to the certification server computing device, and/or a certification server memory operatively connected to the certification server computing device for storing the received respective wind speed data, tide data and/or water level data. In some embodiments, the certification server computing device of the certification server 306 can generate a data model, for example a historical storm model, a wind speed damage model, a historical tide model, a tide damage model, a historical storm surge (e.g., water level) model, and/or a storm surge damage model and the generated data model can be transmitted by the certification server communication interface to another location on the communication network 316. In some embodiments, the certification server computing device of the certification server 306 can generate a certification report based on the received wind speed data and the generated data model, and/or the received tide data and the generated data model, and/or on the received water level data and the generated water level model, and the certification report can be transmitted by the certification server communication interface to another location on the communication network 316. In some embodiments, the certification server 306 can be disposed at a geographic location that is remote from (i.e., geographically distant from) the wind station system 100 or tide station system 200, the data server 302, the user device 304 and/or the contract payout server 308, whereas in other embodiments, the contract payout server can be disposed at the same geographic location as the wind station system, the data server, the user device and/or the contract payout server.

In some embodiments, the certification server communication interface can be operatively coupled to an external network to receive parametric data from a parametric data station and transmit a signal for adjust the thresholds to a payout server communication interface of a payout server. The certification server memory can store parametric thresholds. The certification server computing device can determine whether a received parametric data exceed the parametric threshold. Based on the determination, the certification server computing device can generate the signal to cause a reduction of the first threshold. The certification server can receive different types of parametric data and compare each type to a corresponding threshold. The determination can be based on one or more of the different types of parametric data exceeding a corresponding threshold. The certification server can receive parametric data from one or more different sensor of a same type. The determination can be based on one or more of the parametric data from the one or more different sensors exceeding a threshold for that parametric type. In some embodiments, the threshold for a single parametric type can vary based on other factors, such as location of the parametric sensor, distance from an insured entity, altitude, etc.

Although the data server 302 and the user device 304 are illustrated as separate devices in FIG. 3, the functions performed by the data server and the user device can be performed using any suitable number of devices in some embodiments. For example, in some embodiments, the functions performed by either the data server 302 or the user device 304 can be performed on a single device. As another example, in some embodiments, multiple devices can be used to implement the functions performed by the data server 302 and the user device 304.

Although the data server 302, certification server 306, and the contract payout server 308 are illustrated as separate devices in FIG. 3, the functions performed by the data server, certification server and the contract payout server can be performed using any suitable number of devices in some embodiments. For example, in some embodiments, the functions performed by either the data server 302, the certification server 306, or the contract payout server 308 can be performed on a single device. As another example, in some embodiments, multiple devices can be used to implement the functions performed by the data server 302, the certification server 306 and the contract payout server 308.

Although only three wind stations 310, one tide station 312, one certification server 306, one contract payout server 308, one data server 302, two user devices 304 and three third-party server 318 are shown in FIG. 3 to avoid over-complicating the figure, any suitable number and/or any suitable types of wind stations, tide stations, data servers, user devices and third-party servers can be used in some embodiments.

The data server 302, the user device 304, the wind station computing device 108 and the tide station computing device 208 can be implemented using any suitable hardware in some embodiments. For example, in some embodiments, the data server 302, the user device 304, the wind station computing device 108 and the tide station computing device 208 can be implemented using any suitable general purpose computer or special purpose computer. In another example, the wind station computing device 108 may be implemented using a special purpose computer. In yet another example, the tide station computing device 208 may be implemented using a special purpose computer. Any such general purpose computer or special purpose computer can include any suitable hardware. Such hardware can include a hardware processor, a memory and/or storage, an input device controller, an input device, display/audio drivers, display and audio output circuitry, a communication interface(s), an antenna and a bus as further described herein.

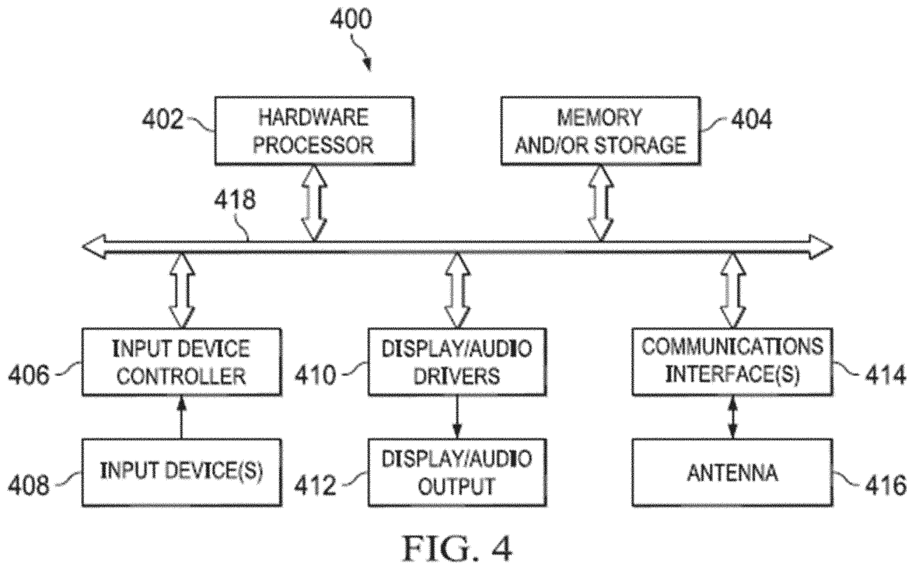

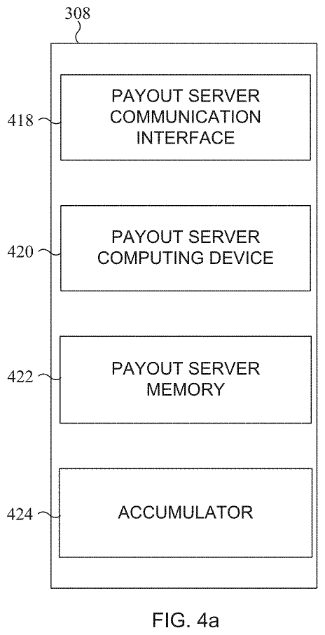

Referring now to FIG. 4, there is illustrated one example of computer hardware 400 implemented as the computing device 108, 208 for the wind station 310 or the tide station 312, respectively, in accordance with respective embodiments. In some other embodiments, any suitable computing device can be used. As illustrated in FIG. 4, the computer hardware 400 can include a hardware processor 402, a memory and/or storage 404, an input device controller 406, an input device 408, display/audio drivers 410, display and audio output devices 412, a communication interface(s) 414, an antenna 416 and a bus 418.

The hardware processor 402 can include any suitable hardware processor, such as a microprocessor, a micro-controller, digital signal processor(s), dedicated logic, and/or any other suitable circuitry for controlling the functioning of a general-purpose computer or a special purpose computer in some embodiments. In some embodiments, the hardware processor 402 can be controlled by a program stored in the memory and/or storage 404. For example, the program can cause the hardware processor 402 to perform the mechanisms and/or processes described herein for managing wind speed data, and/or perform any other suitable actions.

The memory and/or storage 404 can be any suitable memory and/or storage for storing application information, programs, data, and/or any other suitable information in some embodiments. For example, the memory and/or storage 404 can include random access memory (“RAM”), read-only memory (“ROM”), flash memory, hard disk storage, optical media and/or any other suitable memory.

The input device controller 406 can be any suitable circuitry for controlling and receiving input from one or more input devices 408 in some embodiments. For example, the input device controller 406 can be circuitry for receiving input from a touchscreen, from a keyboard, from a mouse, from one or more buttons, from a voice recognition circuit, from a microphone, from a camera, from an optical sensor, from an accelerometer, from a temperature sensor, from a near field sensor, from a wind speed sensor 104 (FIG. 1) or tide sensor 202 (FIG. 2) and/or from any other type of input device 408.

The display/audio drivers 410 can be any suitable circuitry for controlling and driving output to one or more display/audio output devices 412 in some embodiments. For example, the display/audio drivers 410 can be circuitry for driving a touchscreen, a flat-panel display, a cathode ray tube display, a projector, a speaker or speakers and/or any other suitable display and/or presentation devices.

The communication interface(s) 414 can be any suitable circuitry for interfacing with one or more communication networks, such as the communication network 316 shown in FIG. 3 and previously described. For example, the interface(s) 414 can include network interface card circuitry, wireless communication circuitry and/or any other suitable type of communication network circuitry. The communication interface(s) 414 can also include circuitry for interfacing with external devices including the memory and/or storage 404 for storing and/or retrieving wind speed data and/or tide data or water level data from the storage device and/or the memory. In some embodiments, the wind speed data and/or tide data or water level data can be stored in the storage device and/or the memory and/or storage 404 as digital data and/or can be transmitted to, or received from, the communication network as digital data.

The antenna 416 can be any of one or more suitable antennas for wirelessly communicating with a communication network (e.g., the communication network 316 of FIG. 3 as previously described) in some embodiments. In some embodiments, the antenna 416 can be internal to the computer hardware 400 or omitted.

The bus 418 can be any suitable mechanism for communicating between two or more components in some embodiments. The communication between the components of the computer hardware 400 along the data bus 418 can be implemented as digital data.

Any other suitable components can be included in computer hardware 400 in accordance with some embodiments.

According to FIG. 4a, the payout server 308 can include a payout server communication interface 418, a payout server computing device 420, a payout server memory 422, and an accumulator 424. The payout server communication interface 418 can be configured to receive invoices. The received invoices can be transmitted by electronic devices of entities (e.g. external entities) involved with recovery of the entity after a destructive event. The payout server computing device 420 can be used to process (fund) the invoices. The payout server memory 422 can store a funding thresholds and payout limits. In some embodiments, the accumulator 424 can be a hardware processor. The accumulator 424 can track a total amount of receive invoices. The accumulator 424 can determine whether a total amount of received invoices is greater than a first threshold and in respond to the determination, can control the payout communication interface ability to provide funds. For example, when the total amount of invoices is less than the first threshold, the accumulator 424 controls the payout server communication interface 418 to withhold invoices from the payout server computing device 420. When the total amounts of invoices is greater than or equal to the first threshold, the accumulator 424 can control the payout server communication interface 418 to provide the received invoices to the payout server computing device 420 for processing payments. When the total amount of invoices is greater than or equal to the first threshold, the accumulator 424 can also determine whether the total amount of invoices processed is greater than a payout limit. When the total amount of invoices processed is not greater than a payout limit, the accumulator 424 continues to provide invoices to the payout server computing device 420. When the total amount of invoices is greater than the payout limit, the accumulator 424 can control the payout server communication interface 418 to stop providing the received invoices to payout server computing device 420. The accumulator 424 can have multiple threshold each with a payout limit. The thresholds are typically equal to or greater than a previous threshold plus that specific threshold's payout limit. The payout server communication interface 418 can receive invoices that are already processed or paid out by an external party. This could include the insured entity, another primary insurance company, or possibly a secondary insurance company. When an amount of damages requires some portion of the deductible to by paid (either before one or more primary insurance companies), an insured entity can be responsible for that amount. Once the first threshold has been reached, any further payments by the insured entity would reduce the second threshold up to a point of the max payout amount of the primary insurance companies.

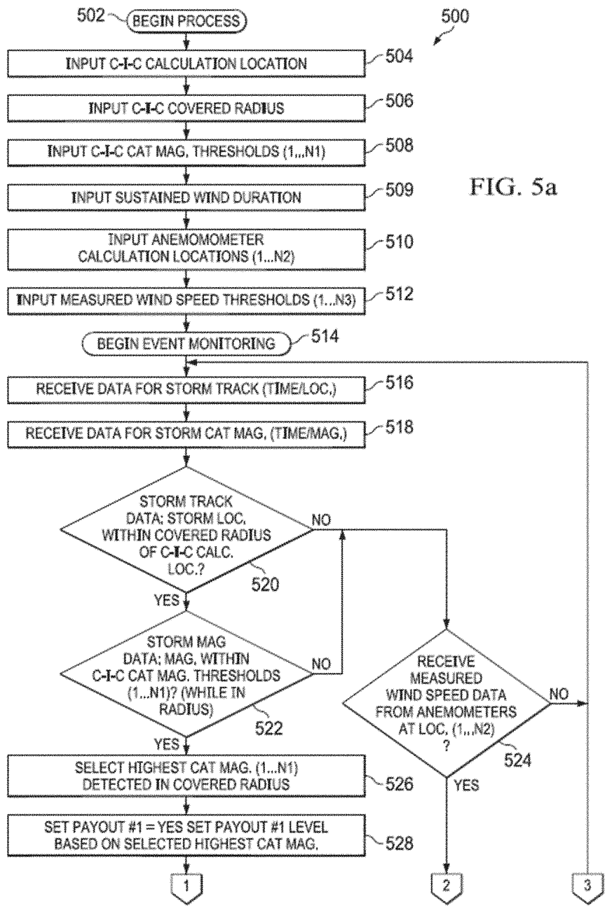

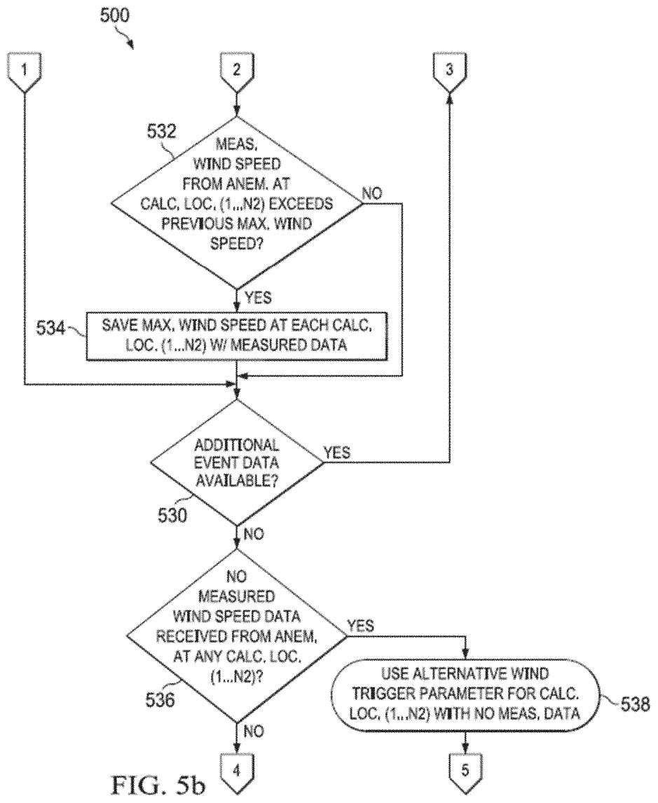

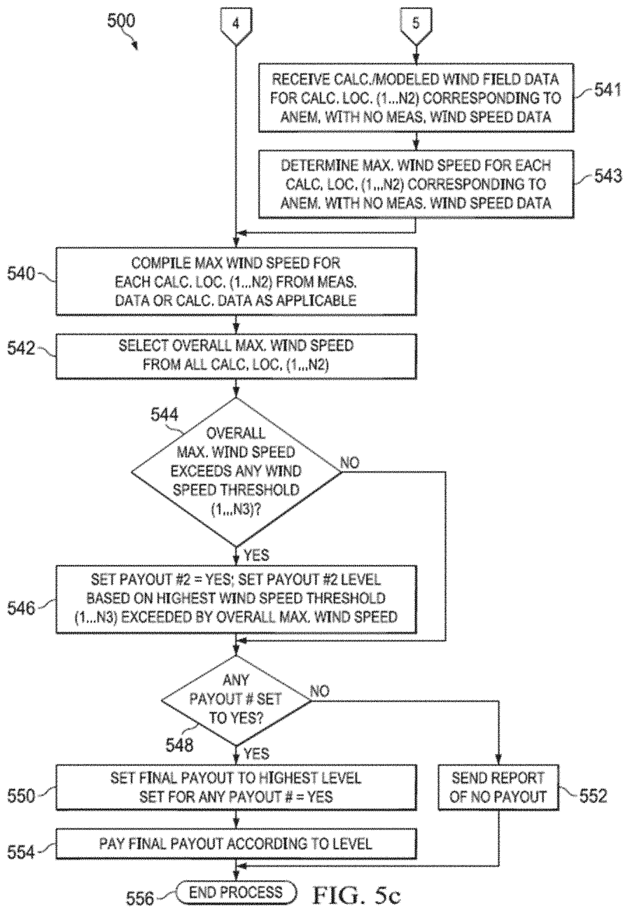

Referring now to FIGS. 5a, 5b and 5c, there is illustrated an example of a process 500 for managing multi-trigger parametric data in accordance with some embodiments of the disclosed subject matter. In FIGS. 5a-5c, the example process 500 is illustrated by means of a block diagram wherein each block represents a step or steps of the process. In some embodiments, additional blocks can be present in between and/or in series with and/or in parallel with the blocks illustrated and/or additional steps can be present between and/or in series with and/or in parallel with the steps described.

In some embodiments, the process 500 can be executed by any device or combination of devices. For example, the process 500 can be executed at least in part by one or more data servers (e.g. the data server 302 of FIG. 3), one or more user devices (e.g., the user device 304 of FIG. 3), one or more wind stations (e.g., the wind stations 310 of FIG. 3 and/or wind station system 100 of FIG. 1), one or more tide stations (e.g., the tide station 312 of FIG. 3 and/or tide station system 200 of FIG. 2a), one or more certification servers (e.g., the certification server 306 of FIG. 3), one or more third-party servers (e.g., third-party payout service 318′, the National Hurricane Center server 318″ or the calculated wind model server 318′″ of FIG. 3), one or more contract payout servers 308 and/or any other suitable device.

The process 500 can define a plurality of trigger events, wherein each of the plurality of trigger events includes one or more predetermined trigger event data types and values. Two examples of trigger events are a Parametric Storm Category Proximity event (also known as “Cat-In-A-Circle” event or “C-I-C” event) and a Parametric Wind Speed event (“PWS” event). A C-I-C trigger event can be defined by parameter data types including, but not limited to, a C-I-C calculation location, a C-I-C covered radius, one or more C-I-C storm magnitude thresholds (1 . . . N₁), and/or one or more C-I-C payout fractions corresponding to each of the C-I-C storm magnitude thresholds. Values for each of these parameters can be provided to initialize the process. A PWS trigger event can be defined by parameters data types including, but not limited to, a PWS sustained wind speed duration, one or more PWS wind speed calculation locations (1 . . . N₂), one or more PWS wind speed thresholds (1 . . . N₃), and/or one or more PWS payout fractions corresponding to each of the PWS wind speed thresholds. Values for each of these parameters can be provided to initialize the process.

Referring now first to FIG. 5a, in some embodiments, the process 500 can begin at block 502 having steps of initiating the definition of one or more trigger events. In the illustrated embodiment, the process 500 can include blocks 504, 506 and 508 relating to defining a C-I-C event as one trigger event. In some embodiments, the process 500 can include block 504 having steps wherein the C-I-C event can be defined by a parameter data type including a C-I-C calculation location and one or more calculation location values is entered. The steps of blocks 504, 506 and 508 can follow the steps of block 502, and the steps of each block 504, 506 and 508 can be performed in any order (i.e., before, after or concurrently) relative to the remaining of these blocks. In some embodiments, the process 500 can include block 506 having steps wherein the C-I-C event can be defined by a parameter data type including a C-I-C covered radius and one or more covered radius values is entered. In some embodiments, the process 500 can include block 508 having steps wherein the C-I-C event can be defined by a parameter data type including one or more C-I-C storm magnitude thresholds (1 . . . N₁) and one or more storm magnitude threshold values are entered. In some embodiments, the block 508 can further include steps wherein one or more C-I-C payout fractions (i.e., values) can be entered corresponding to each of the C-I-C storm magnitude thresholds. As examples: in some embodiment, the C-I-C calculation location of block 504 can be a specified geographic latitude/longitude combination; in some embodiments the C-I-C covered radius can be a distance in miles or kilometers; in some embodiments the one or more C-I-C storm magnitude thresholds (1 . . . N₁) can be tropical storm magnitudes (“categories” or “Cats”) according to the National Hurricane Center (“NHC”) or other selected agency; and in some embodiments the corresponding one or more C-I-C payout fractions can be percentages of a predetermined maximum amount (“MaxPayout”). The steps of each block 504, 506 and 508 can be performed in any order (i.e., before, after or concurrently) relative to the remaining blocks. As further examples, if C-I-C storm magnitude thresholds is selected as the parameter data type in block 508 and if NHC Cat 4 and Cat 5 are selected as C-I-C storm magnitude threshold values, then N₁=2 and the set of N₁ C-I-C storm magnitude thresholds would be (CAT4, CAT5). Continuing with a further example, the C-I-C payout fractions corresponding to each Cat (1 . . . N₁) can be set as desired, e.g., for CAT4, the payout fraction=50% of MaxPayout and for CAT5, the payout fraction=100% of MaxPayout; thus in this example the set of N₁ C-I-C payout fractions would be (50%, 100%). The exemplary C-I-C parametric event can be satisfied (i.e., set to “YES”) if a storm track passes within the C-I-C covered radius (e.g., 20 miles) from the C-I-C calculation location (e.g., lat=X, lon=Y) with a reported magnitude (e.g., NHC-reported CAT) equal to one of the C-I-C storm magnitude thresholds, and once the C-I-C parametric event is satisfied, then the C-I-C payout fraction corresponding to the maximum exceeded storm magnitude threshold would be triggered.

In the illustrated embodiment, the process 500 can include blocks 509, 510 and 512 relating to defining a PWS event as another trigger event. In some embodiments, the process 500 can include block 509 having steps wherein the PWS event can be defined by a parameter data type including a PWS sustained wind speed duration and a sustained wind speed duration value is entered. In some embodiments, the process 500 can include block 510 having steps wherein the PWS event can be defined by a parameter data type including one or more PWS wind speed calculation locations (1 . . . N₂) and one or more wind speed calculation location values are entered. The steps of blocks 509, 510 and 512 can follow the steps of block 502, and the steps of each block 509, 510 and 512 can be performed in any order (i.e., before, after or concurrently) relative to the remaining of these blocks. In some embodiments, the process 500 can include block 512 having steps wherein the PWS event can be defined by a parameter data type including one or more PWS wind speed thresholds (1 . . . N₃) and one or more wind speed thresholds values are entered. In some embodiments, the block 512 can further include steps wherein one or more PWS payout fractions (i.e., values) can be entered corresponding to each of the PWS wind speed thresholds. As examples: in some embodiments, the PWS sustained wind speed duration of block 509 can be a specified time period (e.g., 60-seconds); in some embodiments, each PWS wind speed calculation location (1 . . . N₂) of block 510 can be the specified geographic latitude/longitude combination of a wind station 310 (e.g., with anemometer 104); in some embodiments, each PWS wind speed threshold (1 . . . N₃) of block 512 can be a range of wind speeds (e.g., in miles per hour); and in some embodiments, the corresponding PWS payout fractions can be percentages of a predetermined maximum amount (“MaxPayout”). As further examples, if PWS wind speed duration is selected as the parameter type in block 509 and if three wind calculation locations can be specified (N₂=3) with PWS calculation location set (lat₁/lon₁, lat₂/lon₂, lat₃/lon₃) and two PWS wind speed thresholds can be specified (N₃=2) with PWS wind speed threshold(1) being (130 mph<=wind speed<157 mph) and PWS wind speed threshold(2) being (157 mph<=wind speed). Continuing with a further example, the PWS payout fractions corresponding to the PWS wind thresholds can be PWS payout fraction(1)=50% of MaxPayout and PWS threshold(2)=100% of MaxPayout. The exemplary PWS parametric event can be satisfied (i.e., set to “YES”) if, at any of the PWS calculation locations (1 . . . N₂), the storm wind speed data exceeds one of the PWS wind speed thresholds (1 . . . N₃) for the specified time duration (or longer), and once the PWS parameter event is satisfied, the triggered PWS payout fraction is the fraction corresponding to the highest PWS wind speed threshold exceeded. In some embodiments, the maximum sustained PWS wind speed at any of the PWS calculation locations can first be determined, and then only the value of the maximum PWS wind speed can be compared against the PWS wind speed thresholds to determine if a trigger condition is satisfied. In other embodiments, the highest sustained PWS wind speed at each PWS calculation location can first be determined and compared to the PWS wind speed thresholds to determine if a trigger condition is satisfied for that location, and then all of the satisfied trigger conditions (if any) can compared to determine the highest trigger condition satisfied.

Referring still to FIG. 5a, the process 500 can include block 514 that includes steps of ending the initialization procedure and beginning the event monitoring procedure. In some embodiments, the steps of block 514 can follow blocks 504, 506, 508, 509, 510 and 512. In some embodiments, the process 500 can include block 516 having steps wherein the storm track data is received comprising time and location values for the storm. In some embodiments, the steps of block 516 can follow the steps of block 514. In some embodiments, the storm location values may be a set of latitude/longitude coordinate pairs defining the path of the center of the hurricane's eye as periodically determined by the relevant authorities. In some embodiments, the process 500 can include block 518 having steps wherein the storm magnitude data is received comprising times and magnitude (or category) locations for the storm. In some embodiments, the storm magnitude values may be a set of magnitude/category values for the storm as periodically determined by the relevant authorities. The steps of each block 516 and 518 can be performed in any order (i.e., before, after or concurrently) relative to the remaining of these blocks.

In some embodiments, the process 500 can include block 520 having steps of evaluating the storm track data (e.g., from block 516) and determining, for a given time=t, if the storm track location for time=t is within the specified C-I-C covered radius (e.g., from block 506) relative to the C-I-C calculation location (e.g., from block 504). In some embodiments, the steps of block 520 can follow the steps of block 516 and 518. If the result of block 516 is “YES,” then the process 500 proceeds to block 522, whereas if the result of block 516 is “NO,” then the process 500 proceeds to the block 524.

In some embodiments, the process 500 can include block 522 having steps of evaluating the storm magnitude data (e.g., from block 518) and determining, for a given time=t, if the storm magnitude is within the specified C-I-C magnitude thresholds (e.g., from block 508), it having been also determined (in block 520) that the storm track location is within the specified C-I-C covered radius at time=t. If the result of block 522 is “YES,” (i.e., C-I-C trigger event has occurred) then the process 500 proceeds to block 526, whereas if the result of block 522 is “NO,” then the process 500 proceeds to the block 524.

In some embodiments, the process 500 can include block 526 having steps of selecting the highest CAT/magnitude threshold among the thresholds (1 . . . N1) (block 508) that is satisfied by the received CAT/magnitude data (block 518) for time=t.

In some embodiments, the process 500 can include block 528 having steps of setting a trigger status of Payout #1 to “YES” (the default trigger status is “NO”) and determining a level (i.e., value) of Payout #1 according to a correspondence between the maximum CAT/magnitude threshold satisfied according to the steps of block 526 and the C-I-C payout fraction corresponding to the selected maximum CAT/magnitude. In some embodiments, the steps of block 528 can follow block 526. Following the steps of block 528, the process 500 continues to block 530 (FIG. 5b) via diagram connector 1.

In some embodiments, the process 500 can include block 524 having steps of determining whether measured wind speed data was received from anemometers at anemometer calculation locations (1 . . . N2). If the result of block 524 is “YES,” then the process 500 proceeds to block 532 (FIG. 5b) via diagram connector 2. If the result of block 524 is “NO,” then the process 500 loops back to block 516 to continue the event monitoring procedure.

Referring now also to FIG. 5b, in some embodiments, the process 500 can include block 532 having steps of evaluating the measured wind speed data from the anemometers at anemometer calculation locations (1 . . . N2) and determining whether the measured wind speed value at time=t exceeds the previous maximum wind speed value. If the result of block 532 is “YES,” then the process 500 proceeds to block 534. If the result of block 532 is “NO,” then the process 500 proceeds to block 530.

In some embodiments, the process 500 can include block 534 having steps of saving (i.e., storing) the measured wind speed value received from block 532 for anemometer calculation location (n) as a new maximum wind speed for that anemometer calculation location. In some embodiments, the process 500 then proceeds to block 530.

In some embodiments, the process 500 can include block 530 having steps of determining whether additional event data is available. If the result of block 530 is “YES” (i.e., more data to process), then the process 500 loops back to block 516 (FIG. 5a) via diagram connector 3 to continue the event monitoring procedure. If the result of block 530 is “NO” (i.e., no more data to process), then the process 500 proceeds to block 536. By the action of block 530, the process 500 can iterate through all event data including, but not limited to, the data for each C-I-C calculation location, for each anemometer calculation location and for all times t between t=0 and t=Event End.

In some embodiments, the process 500 can include block 536 having steps of determining whether no measured wind speed data was received from the anemometers at any anemometer calculation location (1 . . . N2). For example, this step can check for data interruptions due to damage to the wind speed station and/or communication links throughout the system hardware 100, 200, 300 and 400. If the result of block 536 is “YES” (i.e., no data received from anemometers at one or more particular calculation locations), then the process 500 proceeds to block 538. If the result of block 532 is “NO” (i.e., data received from all anemometer locations), then the process 500 proceeds to block 540 (FIG. 5c) via diagram connector 4.

In some embodiments, the process 500 can include block 538 having steps of using an alternative wind trigger parameter for anemometer calculation locations (1 . . . N2) where no measured wind speed data was received. The process 500 then proceeds to block 542 (FIG. 5c) via diagram connector 5.

Referring now also to FIG. 5c, in some embodiments, the process 500 can include block 542 having steps of receiving calculated or modeled wind field data for anemometer calculation locations (1 . . . N2) where no measured wind speed data was received. The process 500 then proceeds to block 544.

Referring now also to FIG. 5c, in some embodiments, the process 500 can include block 542 having steps of receiving calculated or modeled wind field data for anemometer calculation locations (1 . . . N2) where no measured wind speed data was received. The process 500 then proceeds to block 544.

In some embodiments, the process 500 can include block 544 having steps of determining, for each anemometer calculation locations (1 . . . N2) where no measured wind speed data was received, a calculated maximum wind speed. This calculated maximum wind speed can be used in the same manner as the measured wind speeds in subsequent processes. The process 500 then proceeds to block 540.

In some embodiments, the process 500 can include block 540 having steps of compiling, for all anemometer calculation locations (1 . . . N2) maximum wind speed data comprising measured wind speed data or calculated wind speed data. The process 500 then proceeds to block 542.

In some embodiments, the process 500 can include block 542 having steps of selecting an overall maximum wind speed for all anemometer calculation locations (1 . . . N2). The process 500 then proceeds to block 544.

In some embodiments, the process 500 can include block 544 having steps of determining whether the overall maximum wind speed (for all anemometer calculation locations (1 . . . N2)) exceeds any of the wind speed thresholds (1 . . . N3). If the result of block 544 is “YES,” then the process 500 proceeds to block 546. If the result of block 544 is “NO,” then the process 500 proceeds to block 548.

In some embodiments, the process 500 can include block 546 having steps of setting a trigger status of Payout #2 to “YES” (the default trigger status is “NO”) and determining a level (i.e., value) of Payout #2 according to a correspondence between the maximum wind speed threshold (1 . . . N3) satisfied according to the steps of block 544 and the PWS payout fraction corresponding to the selected maximum wind speed threshold. The process 500 then proceeds to block 548.

In some embodiments, the process 500 can include block 548 having steps of determining whether any Payout #N has the trigger status=“YES”. If the result of block 548 is “YES,” then the process 500 proceeds to block 550. If the result of block 548 is “NO,” then the process 500 proceeds to block 552.

In some embodiments, the process 500 can include block 550 having steps of setting the Final Payout to the highest level/value set for any Payout #N having a trigger status=“YES.” The process 500 then proceeds to block 554.

In some embodiments, the process 500 can include block 552 having steps of sending a report of “No Payout” for the subject event when the process determines that no payout is indicated by the relevant parameters and measured values. The process 500 then proceeds to block 556.

In some embodiments, the process 500 can include block 554 having steps of paying a Final Payout according to the payout level/value set in block 550. In some embodiments, the process can also include steps of sending a report of “Payout for Event” for the subject event when the process determines that a payout is indicated by the relevant parameters and measured values. The process 500 then proceeds to block 556.

In some embodiments, the process 500 can include block 556 having steps of ending the multi-trigger parametric data management process.

In some embodiments of the multi-trigger parametric data process 500, the storm wind speed data used for the PWS wind speed thresholds (block 512) is measured wind speed data obtained from the one or more wind stations 310 (e.g., anemometers) at the specified PWS calculation locations. In other embodiments, the storm wind speed data is obtained from a calculated (i.e., modeled) wind field data set. The calculated wind field data set can be a data set provided by the operator of the process or obtained by the operator of the process from a third-party provider such as a RMS® North Atlantic Hurricane Models from Risk Management Solutions, Inc. In still other embodiments, storm wind speed data used for the PWS wind speed thresholds can be obtained from both measured wind speed data and from calculated wind field data.

In the process 500 illustrated in FIGS. 5a-5c, the primary source of storm wind speed data used for the PWS wind speed threshold comparison is measured wind speed data from wind stations 310. However, in circumstances wherein measured wind speed data is not available from one or more of the PWS calculation locations, then a secondary (i.e., “backup”) source of storm wind speed data is used for the PWS wind speed threshold comparison at those PWS calculation locations. For example, at PWS calculation locations where no measured wind speed data is obtained (block 536), e.g., due to equipment failure, data loss or other unexpected circumstance, then a calculated wind field data set is obtained (blocks 538 and 542) covering the relevant PWS calculation locations, and the maximum (calculated) sustained wind at the relevant PWS calculation location is extracted (block 544) from the wind field data set for use as the PWS wind speed data (block 540). The maximum PWS wind speed is then selected (block 540) from all of the PWS wind speeds at all of the PWS calculation locations using the primary (e.g., measured) wind speed data if available and using the secondary (e.g., calculated) wind speed data if the primary data is not available. The maximum PWS wind speed from all the PWS calculation locations is then compared (block 544) to the PWS wind speed thresholds to determine the maximum PWS wind speed threshold exceeded. If so, the PWS payout fraction associated with the highest PWS wind speed threshold exceeded is triggered (block 546).

In some embodiments of the multi-trigger parametric data process 500, other parametric trigger events can be used in a multi-trigger parametric data process. For example, a Parametric Tide Event (“PTE”) can be defined by parameter data types including, but not limited to, one or more PTE tide calculation locations (1 . . . N₄), one or more PTE tide level thresholds (1 . . . N₅), and one or more PTE payout fractions corresponding to each of the PTE tide level thresholds. Values for each of these parameters are provided to initialize the process. As examples: In some embodiments, the PTE tide level calculation location (1 . . . N₄) can be the specified geographic latitude/longitude combination of a tide station 312 (e.g., with tide gauge/water level gauge 202); in some embodiments, each PTE tide level threshold (1 . . . N₅) can be a range of tide levels (e.g., in feet or inches) provided either in terms of absolute measurement (i.e., above MLLW) or in terms of storm surge variance from predicted (i.e., astronomical) tide levels (e.g., variance=measured water level−predicted water level) for the calculation location; and in some embodiments, the corresponding PTE payout fractions can be percentages of a predetermined maximum amount (“MaxPayout”). The PTE parametric event can be satisfied (i.e., set to “YES”) if, at any of the PTE calculation locations (1 . . . N₄), the tide level data exceeds one of the PTE tide level thresholds (1 . . . N₅). If so, the triggered PTE payout fraction is the fraction corresponding to the highest PTE tide level threshold exceeded. In a similar fashion, an additional parametric trigger event can be a Parametric Flooding Event (“PFE”), which is substantially similar to the PTE, except the water levels of interest are water levels at PFE calculation locations in potential flood areas rather than on tidal coastlines.

In some embodiments, at least some of the above-described blocks and/or steps of the multi-trigger parametric data processes can be executed or performed in any order or sequence not limited to the order and sequence shown in and described in connection with the figures. Also, some of the above blocks and/or steps of FIGS. 5a-5c can be executed or performed substantially simultaneously where appropriate or in parallel to reduce latency and processing times. Additionally or alternatively, some of the above described blocks and/or steps of the processes of FIGS. 5a-5c can be omitted.

In some embodiments, any suitable computer readable media can be used for storing instructions for performing the functions and/or processes herein. For example, in some embodiments, computer readable media can be transitory or non-transitory. For example, nontransitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

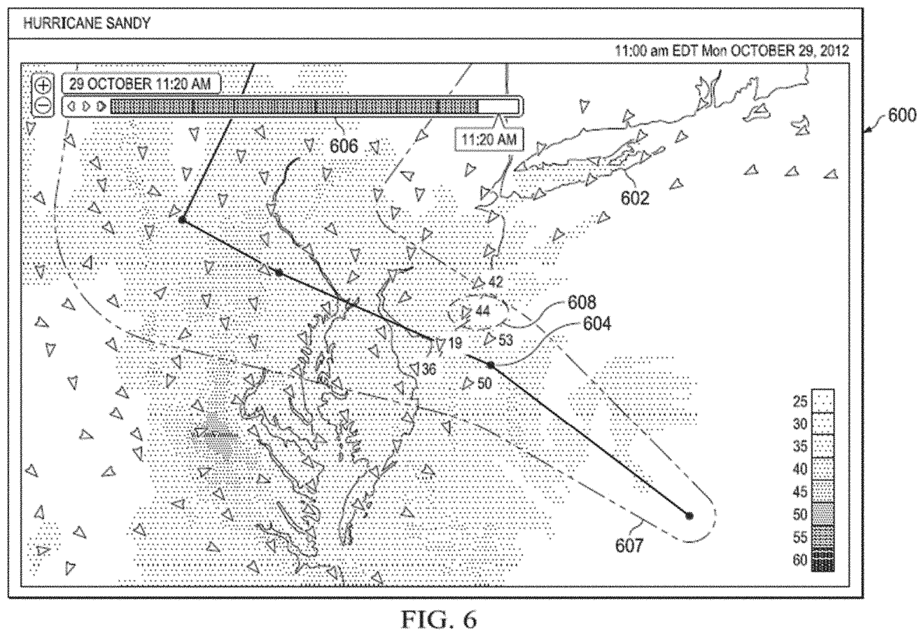

Referring now to FIG. 6, there is illustrated an exemplary storm track map 600 for a tropical storm including underlying geographic features 602, storm path location data 604 and time data 606, hurricane speed wind boundary/envelope 607 and wind speed and direction data 608. This storm track map is exemplary of a data set that can be obtained from third-party servers such as servers at the National Hurricane Center to provide input data, measured data and/or calculated data for use in the processes disclosed herein.

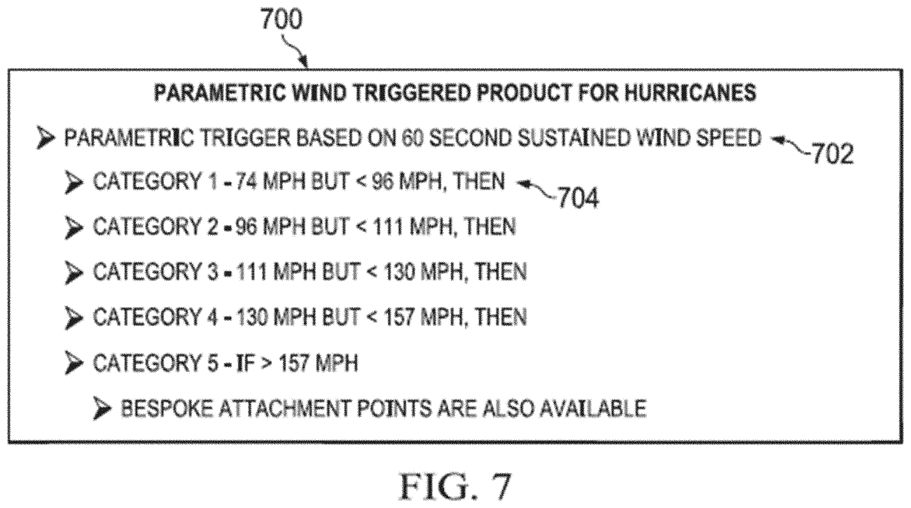

Referring now to FIG. 7, there is illustrated an exemplary set 700 of parametric wind triggers for a hurricane that can used to provide input data (e.g., PWS wind speed thresholds) for evaluating a Parametric Wind Speed portion of a multi-trigger parametric data process in accordance with the embodiments disclosed herein. In the illustrated embodiment, one parametric trigger data type 702 is a sustained wind speed and the trigger value is set for a time=60 seconds. In the illustrated embodiment, five wind speed thresholds 704 are specified, each wind speed threshold corresponding to a respective value on the Cat scale of wind speed.

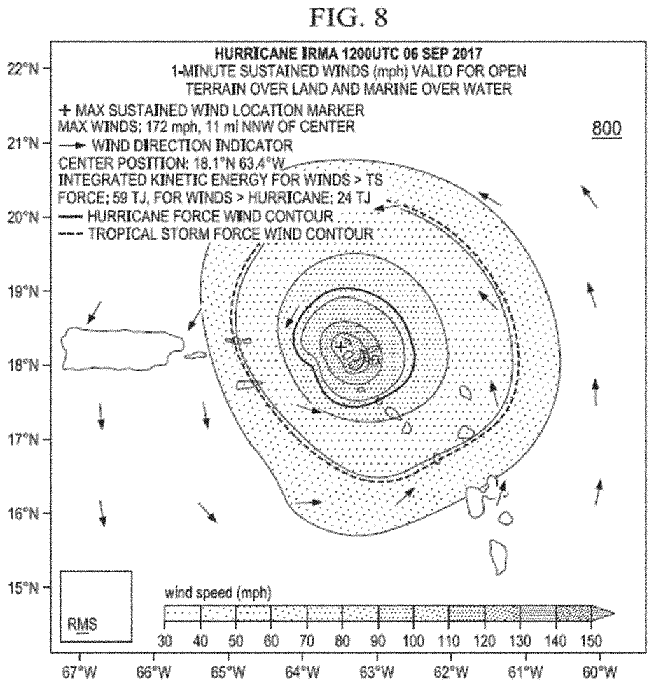

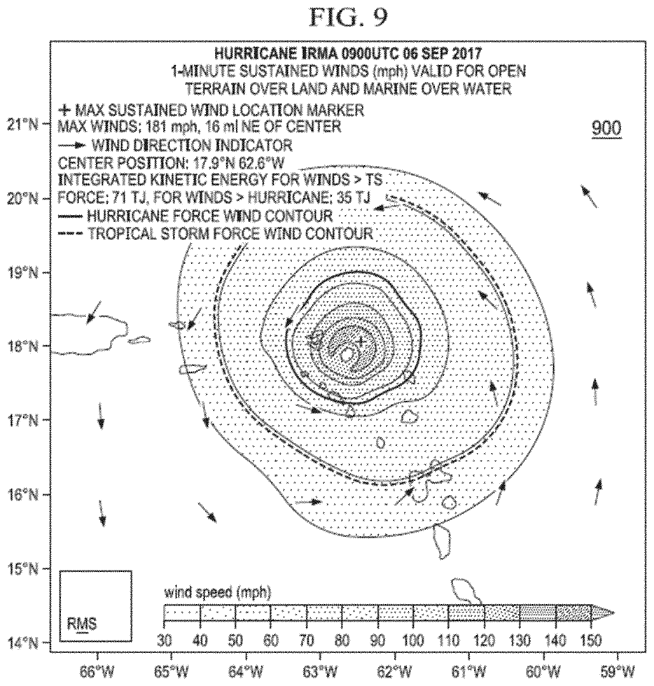

Referring now to FIGS. 8 and 9, there are illustrated two different calculated (i.e., modeled) wind field footprint charts 800 and 900 for an exemplary tropical storm (i.e., Hurricane Irma, 2017) at two different specified times in accordance with another type of parametric data used in embodiments disclosed herein. These wind field charts are exemplary of RMS® data sets that can be obtained from third-party servers such as servers at the Risk Management Solutions, Inc. to provide input data, measured data and/or calculated data for use in the processes disclosed herein. In the process illustrated in FIG. 5a-5c, calculated wind field charts or similar calculated (i.e., modeled) data sets can be used as a source of secondary (“backup”) wind speed data in cases (e.g., blocks 538, 542 and 544 of FIG. 5b) where measured wind speed data (i.e., from specific anemometers) is not available. In other embodiments, calculated/modeled wind field charts or similar data sets can be used a primary wind speed data for some or all of the calculation locations.

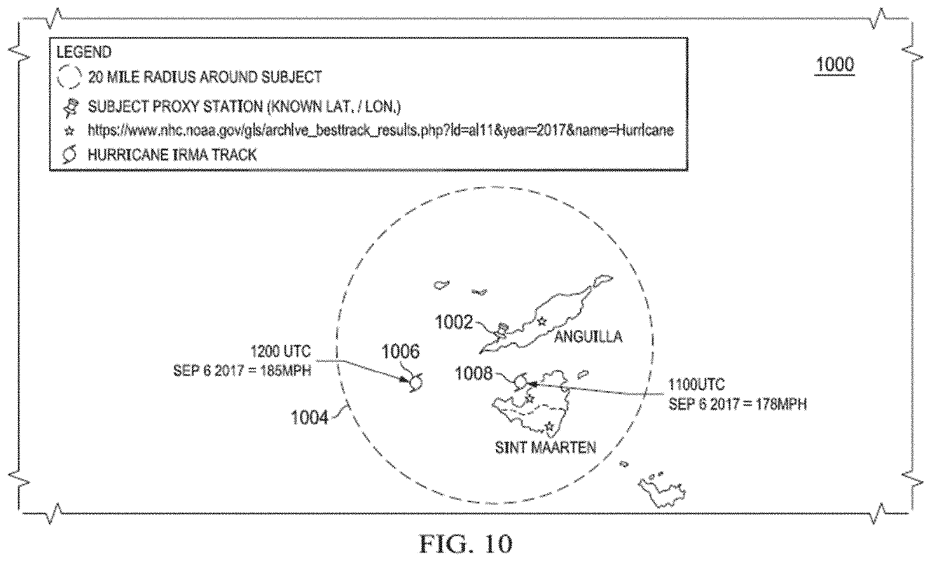

Referring now to FIG. 10, there is illustrated an exemplary coverage territory map 1000 for a Cat-In-A-Circle (“C-I-C”) type parametric process for a hurricane. In the example map, the C-I-C calculation location 1002 has input data of lat 18.177581/lon −63.144625 and the C-I-C covered radius 1004 has input data of 20 miles. Two storm track data points 1006 and 1008 are provided representing the location and wind speed of Hurricane Irma 2017 at 1100 UTC and 1200 UTC, respectively. Both of the illustrated storm track data points 1006 and 1008 lie within the 20-mile CIC covered radius 1004 from the calculation location 1002, and thus can potentially trigger a C-I-C depending upon a comparison of the reported wind speed data and the previously designated C-I-C storm magnitude thresholds.

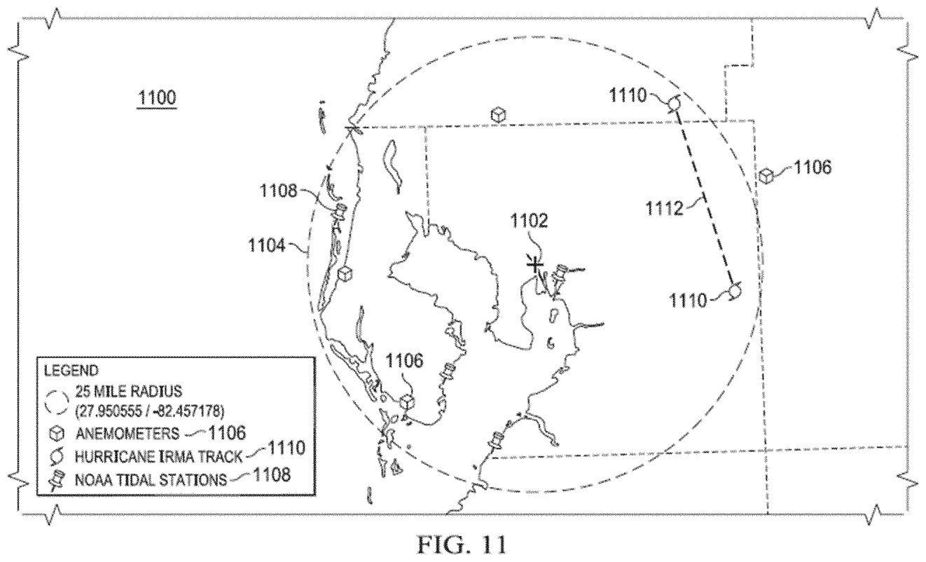

Referring now to FIG. 11, there is illustrated an exemplary triggering mechanisms map 1100 for a multi-trigger parametric data process including Cat-In-A-Circle (C-I-C) Parametric event, Parametric Wind Speed (PWS) event and Parametric Tide (PTE) event. Illustrated are input data for these processes including the C-I-C calculation location 1102 and C-I-C covered radius 1104, PWS calculation locations 1106 (i.e., anemometer locations) and PTE locations 1108 (i.e., NOAA tidal stations). Also illustrated are two storm track data points 1110 and an approximate path line 1112 (shown in dashed lines) for Hurricane Irma 2017 that can be used for evaluating the various trigger events. Each respective triggering condition can define a plurality of respective levels to be met and payout fractions corresponding thereto. The payout for the event can be the maximum amount multiplied by the maximum met payout fraction for all of the triggering conditions.

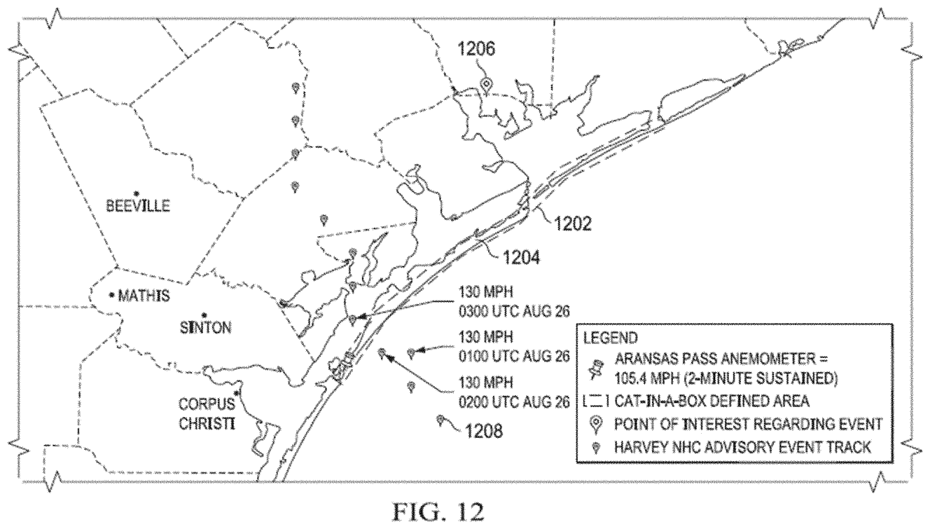

Referring now to FIG. 12, there is illustrated another exemplary triggering mechanisms/exposure map 1200 showing multiple-trigger input data and parametric data values. The first triggering condition is a Cat-in-a-Box, i.e., storm track of predefined magnitude (i.e., CAT) crossing a first predefined geographic location, wherein the first predefined geographical location is an elongated polygon 1202 defined by a plurality of latitude/longitude points to roughly correlate with certain geographic features of interest 1204, e.g., barrier islands. The second triggering condition is a measured wind speed at a second predefined geographic location, namely, an actual anemometer location 1206. Storm track parametric data from event Hurricane Harvey include announced storm track data points 1208 released by the NHC, with each storm track data point including respective time, position and wind speed data. Each respective triggering condition can define a plurality of respective levels to be met and payout fractions corresponding thereto. The payout for the event can be the maximum amount multiplied by the maximum met payout fraction for all of the triggering conditions.

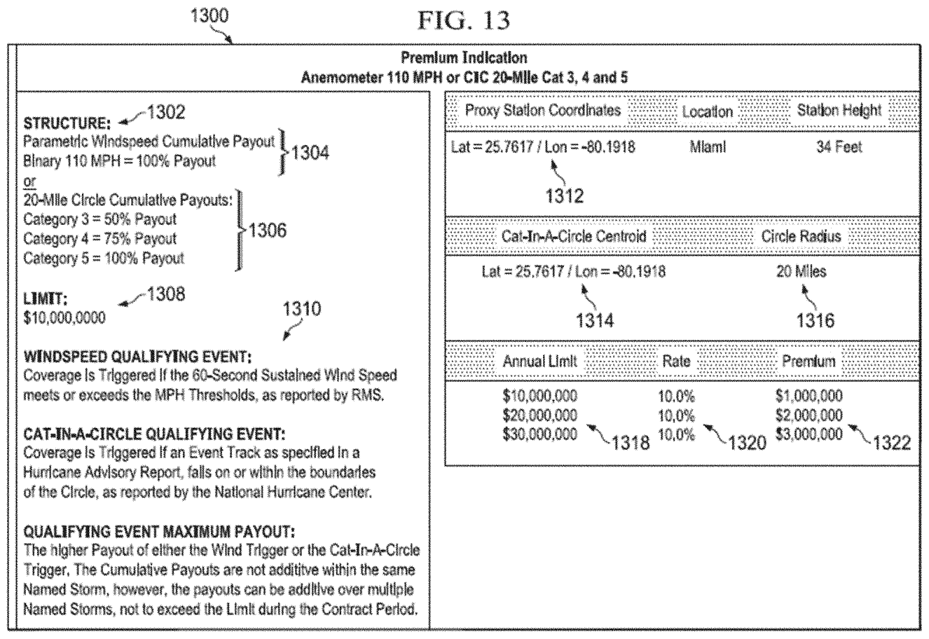

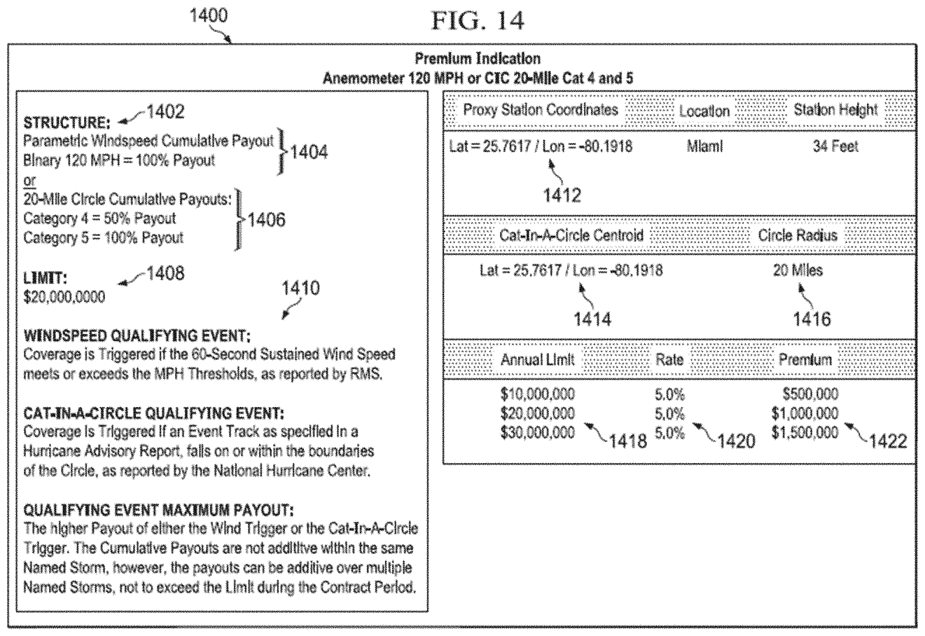

Referring now to FIGS. 13 and 14, there are illustrated two exemplary premium indications 1300 and 1400 based on multi-trigger (e.g., binary) parametric data management and transactions in accordance with embodiments of the disclosed subject matter. The parameter values provided on the premium indications 1300, 1400 represent input data for a multi-trigger parametric process including, but not limited to, the process 500 shown in FIGS. 5a-5c that can be used to determine whether a multi-trigger parametric event has been triggered. If so, the process can determine which threshold level of the parameters are triggered by the event and the associated level of payout specified by the input values.

Referring first to FIG. 13, in the illustrated embodiment, the premium indication 1300 can include a multi-trigger structure portion 1302 specifying a first parametric trigger event 1304 and a second parametric trigger event 1306. In the illustrated embodiment, the first parametric trigger event 1304 can be a wind speed event data type having a parametric trigger value=110 MPH. Triggering the first parametric trigger event 1304 results in a Payout #1 with payout fraction set at 100% of MaxPayout. In the illustrated embodiment, the second parametric trigger event 1306 can be a Cat-In-A-Circle event data type having a parametric trigger value=20 Mile Circle. Triggering the second parametric trigger event 1306 results in a Payout #2 with payout fraction set to 50%, 75% or 100% of MaxPayout according to correspondence between the Category (Cat) level 3, 4, or 5 (respectively) of the storm when it is within the parametric circle. In the illustrated embodiment, the premium indication 1300 can include a limit portion 1308 specifying the value for MaxPayout, in this example, MaxPayout=$10,000,000. In the illustrated embodiment, the premium indication 1300 can include an Information portion 1310 providing further details of the parametric trigger events 1304 and 1306 and of the maximum payout conditions (e.g., for blocks 550 and 554 of FIG. 5c). In the illustrated embodiment, the premium indication 1300 can include an input section including location coordinates 1312 for the C-I-C wind speed calculation location (e.g., for block 504 of FIG. 5a), Cat-In-A-Circle center location coordinates 1314 and radius 1316 (e.g., for block 506 of FIG. 5a). In the illustrated embodiment, the premium indication 1300 can include respective annual limit values 1318, coverage rate values 1320 and premium amount values 1322 corresponding to the desired MaxPayout requested by a purchaser. In other embodiments, any of the parametric data types and values in the premium indication 1300 can be changed, modified, or substituted in accordance with the purchaser's requirements and/or type of risk to be insured against.

Referring now to FIG. 14, in the illustrated embodiment, the premium indication 1400 can include a multi-trigger structure portion 1402 specifying a first parametric trigger event 1404 and a second parametric trigger event 1406. In the illustrated embodiment, the first parametric trigger event 1404 can be a wind speed event data type having a parametric trigger value=120 MPH. Triggering the first parametric trigger event 1404 results in a Payout #1 with payout fraction set at 100% of MaxPayout. In the illustrated embodiment, the second parametric trigger event 1406 can be a Cat-In-A-Circle event data type having a parametric trigger value=20 Mile Circle. Triggering the second parametric trigger event 1406 results in a Payout #2 with payout fraction set to 50% or 100% of MaxPayout according to correspondence between the Category (Cat) level 4 or 5 (respectively) of the storm when it is within the parametric circle. In the illustrated embodiment, the premium indication 1400 can include a Limit portion 1408 specifying the value for MaxPayout, in this example, MaxPayout=$20,000,000. In the illustrated embodiment, the premium indication 1400 can include an Information portion 1410 providing further details of the parametric trigger events 1404 and 1406 and of the maximum payout conditions (e.g., for blocks 550 and 554 of FIG. 5c). In the illustrated embodiment, the premium indication 1400 can include an input section including location coordinates 1412 for the C-I-C wind speed calculation location (e.g., for block 504 of FIG. 5a), Cat-In-A-Circle center location coordinates 1414 and radius 1416 (e.g., for block 506 of FIG. 5a). In the illustrated embodiment, the premium indication 1400 can include respective annual limit values 1418, coverage rate values 1420 and premium amount values 1422 corresponding to the desired MaxPayout requested by a purchaser. In other embodiments, any of the parametric data types and values in the premium indication 1300 can be changed, modified, or substituted in accordance with the purchaser's requirements and/or type of risk to be insured against.

In accordance with additional aspects and embodiments of the disclosed subject matter, mechanisms (which can include methods, systems, and media) for managing seismic data are described herein.

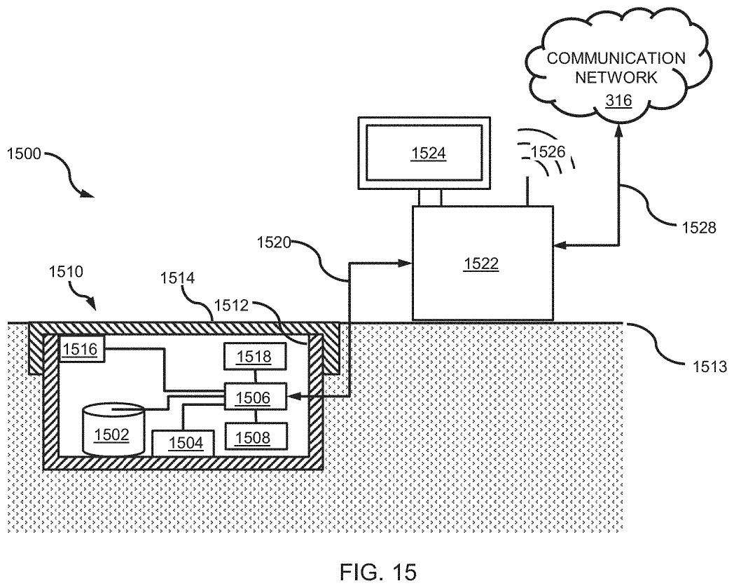

Referring now FIG. 15, there is illustrated an example of a seismic station system 1500 for managing seismic data in accordance with some embodiments of the disclosed subject matter. In some embodiments, the seismic station system 1500 is disposed at a geographic location of interest and manages seismic data for earthquakes and other seismic events occurring at that geographic location. In some embodiments, a particular seismic station system 1500 can manage seismic data for its own geographic location (also known as “local seismic data”) and can also receive seismic signals relevant to other seismic stations, i.e., at different geographic locations (also known as “remote seismic stations”), and produce seismic data for the remote seismic signals (also known as “remote seismic data”). The remote seismic data can be managed by the particular seismic station system 1500 for quality control purposes and/or to certify the seismic data received from the remote seismic stations. As shown, in some embodiments, the seismic system 1500 can include a seismometer 1502, an accelerometer 1504, a data processor 1506 and a memory 1508. Some embodiments of system 1500 can include only one or more seismometers 1502, other embodiment can include only one or more accelerometers 1504, and still other embodiments can include both seismometer(s) and accelerometer(s). Seismic waves (also known as seismic readings) at the geographic location are detected by the seismometer 1502, converted into electrical signals and sent to the data processor 1506. Ground accelerations (also known as acceleration readings) at the geographic location are detected by the accelerometer 1504, converted into electrical signals and sent to the data processor 1506. In various embodiments, the accelerometer 1504 can be a single axis accelerometer or a multi-axis accelerometer, and in particular, it can be a three-axis accelerometer for detecting axial accelerations along three separate axes or a six-axis accelerometer for detecting both axial and rotational accelerations along three separate axes. In various embodiments, the accelerometer 1504 can be a piezoelectric accelerometer, a piezoresistive accelerometer or a capacitive accelerometer. In some embodiments, the accelerometer 1504 can be a micro electro-mechanical systems (“MEMS”) device of the type having a cantilever beam with a proof mass (also known as seismic mass). In other embodiments, the accelerometer 1504 can be a MEMS thermal type using a heated fluid inside a dome to produce a thermal bubble that acts as the proof mass.

The data processor 1506 receives the electrical signals from the seismometer 1502 and accelerometer 1504 and converts the signals into seismic data that can be recorded in the memory 1508. In some embodiments of the system 1500, the seismic data can be digital data and the memory 1508 can be a digital data storage device including, but not limited to, a hard disk drive (“HDD”) or a solid state drive (“SSD”). In other embodiments of the system 1500, the seismic data can be digital data and the memory 1508 can be digital data storage media including, but not limited to, a solid-state non-volatile memory device, a flash memory card, a Secure Digital card or a Compact Flash card. In still other embodiments of the system 1500, the seismic data can be analog data and the memory 1508 can be an analog data storage device or analog data storage media.

Referring still to FIG. 15, in some embodiments of the system 1500, one or more of the seismometer 1502, accelerometer 1504, data processor 1506 and memory 1508 can be disposed inside a secure housing 1510 disposed at the selected geographic location of interest. In the illustrated embodiment, the secure housing 1510 includes a main housing 1512 disposed at or below grade level 1513 and a housing lid or door 1514 that can enclose the relevant system components within the main housing. In other embodiments, the housing 1510 may be disposed above grade, e.g., attached to a foundation, wall or other structural member of a building. The main housing 1512 and the housing lid 1514 can be formed of damage-resistant materials such as concrete or steel to protect the system components during an earthquake or during a structure collapse or fire that may accompany or follow the quake.

To prevent or detect tampering with the system 1500, the housing 1510 can further be equipped with a security device 1516 that can lock the housing and/or can detect opening of the housing lid 1514. The security device 1516 can send electrical signals to the data processor 1506 to indicate opening of the housing lid 1514, and the data processor can convert the signals from the security device into security data that can be sent to the memory 1508 for storage.

The system 1500 can further include a battery 1518 to provide electrical power for operation of the seismometer 1502, accelerometer 1504, data processor 1506 and/or memory 1508. In some embodiments, the battery 1518 can be disposed within the housing 1510 to provide power to the internal system components in case external connections 1520 to the housing are cut or disabled. For example, if a first small earthquake event occurs that cuts off external power e.g., mains power) to the system 1500, the battery 1518 can continue to power the measuring instruments 1502 and 1504, processor 1506 and memory 1508 such that a subsequent larger earthquake event occurring while the mains power is out can be detected and recorded.

The seismic system 1500 can further include a computing device 1522 operably connected to the data processor 1506 and memory 1508. In the illustrated embodiment, the computing device 1522 is located externally to the housing 1510 and connected to equipment within the housing via connection 1520, which can include electrical or fiber optic data cables and/or electrical power cables. In other embodiments, the computing device 1522 can be located inside the housing 1510. In some embodiments, the connection 1520 can comprise a wireless data communication link including, but not limited to, WiFi (i.e., IEEE 1702.11 series), Bluetooth (i.e., IEEE 1702.15 series and Bluetooth SIG series) or other local area wireless technology. The computing device 1522 can include a display device 1524 to display information regarding detected seismic events, the status of the system and system components, messages from the other elements of the system, etc. In the illustrated embodiment, the computing device 1522 is separate from the data processor 1506 and the memory 1508; however, in some other embodiments, the data processor and/or the memory may be components of the computing device 1522. In still other embodiments, the computing device 1522 can comprise a secondary or redundant data processor to augment or “back up” the primary data processor 1506 and/or a secondary or redundant memory to augment or “back up” the primary data memory 1508.

The computing device 1522 can communicate with a communication network 316, for example, either the same network or a network similar to that described in connection with the wind station system 100 of FIG. 1. The communication network 316 can be any suitable combination of one or more wired and/or wireless networks in some embodiments. For example, the communication network 316 can include anyone or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. The computing device 1522 can be connected to the communication network 316 by one or more wireless communication links 1526 and/or one or more hard wired communication links 1528.

Referring now again to FIG. 4, the computer hardware 400 illustrated in connection with the computing device 108 of the wind station system 100 or wind station 310 can similarly be implemented as the computing device 1522 of the seismic station system 1500. The various components and operations of the computer hardware 400 described in connection with computing device 108 can be applied in analogous fashion to the computing device 1522, and therefore will not be repeated.

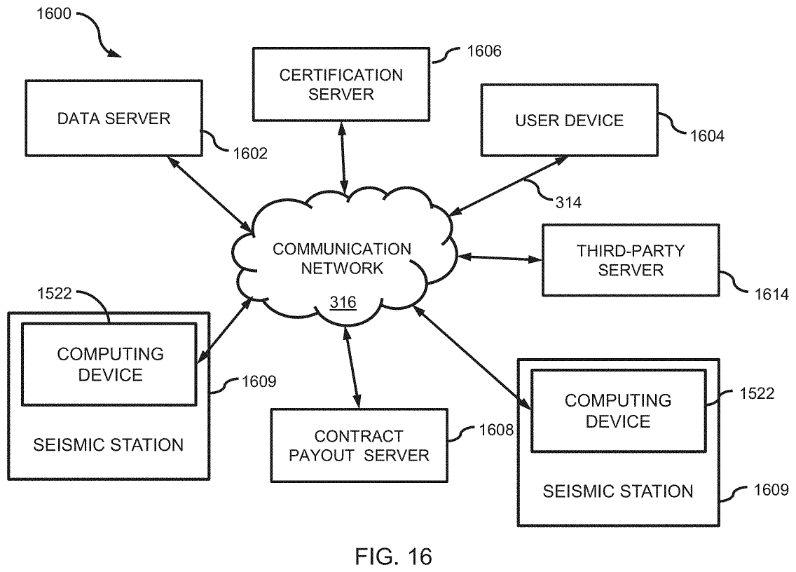

Referring now to FIG. 16, there is illustrated one example of system hardware 1600 for managing seismic data that can be used in accordance with some embodiments of the disclosed subject matter. As illustrated, the system hardware 1600 can include one or more: data servers 1602, user devices 1604, certification servers 1606, contract payout servers 1608 and seismic stations 1609 outfitted with computing devices 1522.

In some embodiments, the seismic station 1609 can be any suitable seismic station configured with a computing device 1522. For example, as shown in FIG. 15, the seismic station 1609 can be the seismic station system 1500 disposed at a particular geographic location.

In some embodiments, the data server 1602 can be any suitable server for storing data and/or delivering the data to a user device 1604. In some embodiments, the data stored by the data server 1602 and/or delivered to the user device 1604 can be implemented as digital data in any digital data format. For example, the data server 1602 can be a server that delivers data to a user device 1604 and/or receives seismic data from a seismic station 1609 via a communication network 316. In some embodiments, the data server 1602 can include a server computing device, a server communication interface operatively connected to the communication network 316 to receive respective seismic data from one or more seismic stations 1609 and operatively connected to the server computing device to provide the received respective seismic data to the server computing device and a server memory disposed at the respective data server location and operatively connected to the server computing device for storing the received respective seismic data. Data stored and/or delivered by the data server 1602 can be any suitable data, such as seismic wave data relating to amplitude, frequency, direction, occurrence time or duration of seismic wave readings at the geographic location of interest, seismic magnitude or intensity readings at the geographical location of interest (e.g., derived by the data processor 1506 from the seismic readings or data), acceleration data relating to amplitude, frequency, direction, occurrence time or duration of ground acceleration at the geographic location of interest, ground velocity data relating to amplitude, frequency, direction, occurrence time or duration at the geographic location of interest (e.g., derived by the data processor 1506 from the acceleration readings), historical seismic event data, contract data, contract payout data and/or any other suitable data. Data can be recorded and uploaded to the data server 1602 by any suitable entity (e.g., a seismic station computing device 1522). In some embodiments, the data server 1602 can be disposed at a geographic location that is remote from (i.e., geographically distant from) the seismic station system 1500, whereas in other embodiments, the data server can be disposed at the same geographic location as the seismic station system. In some embodiments having more than one seismic station system 1500, each respective seismic station system can be disposed at a different respective seismic station location, and the data server 1602 can be disposed at a data server location that is remote from at least one of the respective seismic station locations. In some embodiments having more than one seismic station system 1500 and more than one data server 1602, each respective seismic station system can be disposed at a different respective seismic station location, and each respective data server can be disposed at a different respective data server location, wherein the respective seismic station locations and data server locations are all geographically remote from one another. In some other embodiments, the data server 1602 can be omitted.

As previously described, the communication network 316 can be any suitable combination of one or more wired and/or wireless networks in some embodiments. For example, the communication network 316 can include anyone or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. The user device 1604 can be connected by one or more communications links 314 to the communication network 316, which can be linked via one or more communications links to the data server 1602, and/or seismic stations 1609. The communications links 314 can be any communications links suitable for communicating data among the user device 1604, data server 1602 and seismic stations 1609, such as network links, dial-up links, wireless links, hard-wired links, any other suitable communications links, or any suitable combination of such links. In some embodiments, the data communicated across the communication network 316 and/or communication links 314 can be implemented as digital data in any digital data format.

The user device 1604 can include any one or more user devices suitable for requesting data, searching for data, viewing data, retransmitting data, manipulating data, receiving a user input and/or any other suitable functions. For example, in some embodiments, the user device 1604 can be implemented as a mobile device, such as a mobile phone, a tablet computer, a laptop computer and/or any other suitable mobile device. As another example, in some embodiments, the user device 1604 can be implemented as a non-mobile device such as a desktop computer and/or any other suitable non-mobile device. In some embodiments, the user device 1604 can be disposed at a geographic location that is remote from (i.e., geographically distant from) the seismic station system 1500 and/or the data server 1602, whereas in other embodiments, the user device can be disposed at the same geographic location as the seismic station system and/or the data server.

In some embodiments, the contract payout server 1608 can be any suitable server for causing a contract to be paid out based on seismic data. For example, the contract payout server 1608 can be a server that receives seismic data from a data server 1602 via a communication network 316, and/or determines whether a contract should be paid out based on seismic data and/or causes a third party server 1614 to payout a contract by communicating with the third party server over a communication network 316. The storage of the seismic data and other information, programs, data and/or other suitable information on the contract payout server 1608 can be implemented as digital data in any digital data format. In some embodiments, the contract payout server 1608 can be implemented by hardware analogous to that previously described in connection with FIG. 4. In some embodiments, the payout server 1608 can include a payout server computing device or hardware processor 402, a payout server communication interface 416 operatively connected to the communication network 316 to receive respective certification reports from one or more certification servers 1606 and operatively connected via a data bus 418 to the payout server computing device to provide the received respective certification reports to the payout server computing device, and/or a payout server memory 404 operatively connected via the data bus to the payout server computing device for storing the received respective certification reports. In some embodiments, the payout server computing device 402 can determine if a received respective certification report satisfied the terms of an associated contract, and if so, the payout server can trigger a payout at another location by communicating over the communication network 316. In some embodiments, the contract payout server 1608 can be disposed at a geographic location that is remote from (i.e., geographically distant from) the seismic station system 1500, the data server 1602 and/or the user device 1604, whereas in other embodiments, the contract payout server can be disposed at the same geographic location as the seismic station system, the data server and/or the user device.

In some embodiments, the certification server 1606 can be any suitable server for certifying seismic data. For example, the certification server 1606 can be a server that receives seismic data from a data server 1602 via a communication network 316, and/or stores historical seismic data and/or determines whether seismic data is accurate. The storage of the seismic data and other information, programs, data and/or other suitable information on the certification server 1606 can be implemented as digital data in any digital data format. In some embodiments, the certification server 1606 can be implemented by hardware analogous to that previously described in connection with FIG. 4. In some embodiments, the certification server 1606 can include a certification server computing device or hardware processor 402, a certification server communication interface 416 operatively connected to the communication network 316 to receive respective seismic data from one or more data servers 1602 and operatively connected via a data bus 418 to the certification server computing device to provide the received respective seismic data to the certification server computing device, and/or a certification server memory 404 operatively connected via the data bus to the certification server computing device for storing the received respective seismic data. In some embodiments, the certification server computing device 402 can generate a data model, for example a historical earthquake/seismic event model or a earthquake/seismic event damage model, and the generated data model can be transmitted by the certification server communication interface 414 to another location on the communication network 316. In some embodiments, the certification server computing device 402 can generate a certification report based on the received seismic data and the generated data model, and the certification report can be transmitted by the certification server communication interface 414 to another location on the communication network 316. In some embodiments, the certification server 1606 can be disposed at a geographic location that is remote from (i.e., geographically distant from) the seismic station system 1500, the data server 1602, the user device 1604 and/or the contract payout server 1608, whereas in other embodiments, the contract payout server can be disposed at the same geographic location as the seismic station system, the data server, the user device and/or the contract payout server.

Although the data server 1602 and the user device 1604 are illustrated as separate devices in FIG. 16, the functions performed by the data server and the user device can be performed using any suitable number of devices in some embodiments. For example, in some embodiments, the functions performed by either the data server 1602 or the user device 1604 can be performed on a single device. As another example, in some embodiments, multiple devices can be used to implement the functions performed by the data server 1602 and the user device 1604.

Although the data server 1602, certification server 1606, and the contract payout server 1608 are illustrated as separate devices in FIG. 16, the functions performed by the data server, certification server and the contract payout server can be performed using any suitable number of devices in some embodiments. For example, in some embodiments, the functions performed by either the data server 1602, the certification server 1606, or the contract payout server 1608 can be performed on a single device. As another example, in some embodiments, multiple devices can be used to implement the functions performed by the data server 1602, the certification server 1606 and the contract payout server 1608.

Although only two seismic stations 1609, one certification server 1606, one contract payout server 1608, one data server 1602, one user device 1604 and one third-party server 1614 are shown in FIG. 16 to avoid over-complicating the figure, any suitable number and/or any suitable types of seismic stations, data servers, user devices and third-party servers can be used in some embodiments.

The data server 1602, the user device 1604, and the seismic station computing devices 1522 can be implemented using any suitable hardware in some embodiments. For example, in some embodiments, the data server 1602, the user device 1604 and the seismic station computing devices 1522 can be implemented using any suitable general purpose computer or special purpose computer. For example, the seismic station computing device 1522 may be implemented using a general purpose computer or a special purpose computer. Any such general purpose computer or special purpose computer can include any suitable hardware. For example, referring again to FIG. 4, as illustrated in example computer hardware 400, such hardware can include a hardware processor 402, a memory and/or storage 404, an input device controller 406, an input device 408, display/audio drivers 410, display and audio output circuitry 412, a communication interface(s) 414, an antenna 416 and a bus 418.

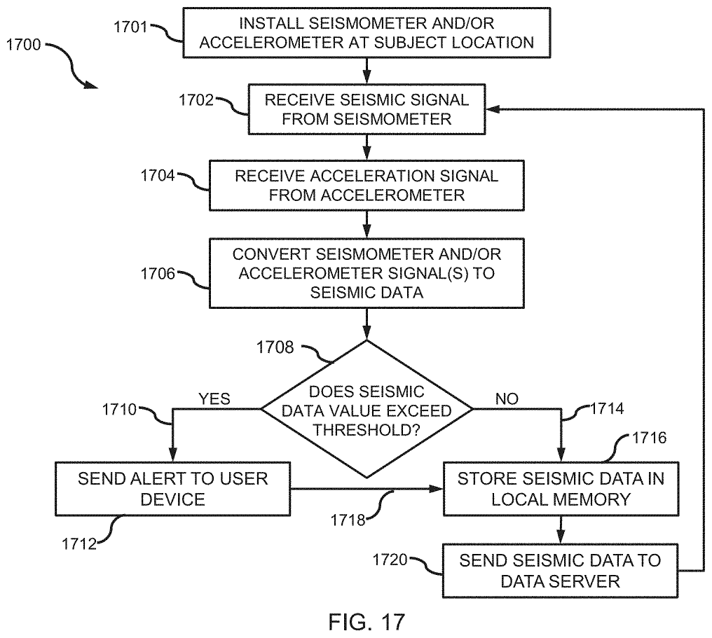

Referring now to FIG. 17, there is illustrated an example of a process 1700 for managing seismic data in accordance with some further embodiments of the disclosed subject matter. In FIG. 17, the example process 1700 is illustrated by means of a block diagram wherein each block represents a step or steps of the process. In some embodiments, additional blocks can be present in between and/or in series with and/or in parallel with the blocks illustrated and/or additional steps can be present between and/or in series with and/or in parallel with the steps described.

In some embodiments, the process 1700 can be executed by any device or combination of devices. For example, the process 1700 can be executed at least in part by one or more data servers (e.g. the data server 1602 of FIG. 16), one or more user devices (e.g., the user device 1604 of FIG. 16), one or more seismic stations (e.g., the seismic stations 1609 of FIG. 16 and/or seismic station system 1500 of FIG. 15), one or more certification servers (e.g., the certification server 1606 of FIG. 16) and/or any other suitable device.

The seismic data managing process 1700 can begin at block 1701 having steps wherein a seismic station 1609 having a seismometer and/or accelerometer is installed at the geographic location of interest. This step allows the process 1700 to utilize seismic data obtained directly at the geographic location of interest rather than relying only on isoseismal maps or estimates based on seismic measurements at other geographic locations. The block 1701 can further have steps wherein the seismic station 1609 is connected to the communication network 316 to send seismic data or other communications to various servers 1602, 1606, 1608 and 1614, devices 1604 and other seismic stations 1609 connected to the network. When multiple seismic stations 1609 are connected together via the communication network 316, the process 1700 can utilize seismic data received from seismic stations at other geographic locations (i.e., remote from the location of interest) to augment and supplement seismic data obtained from the seismic station directly at the geographic location of interest. For example, remote seismic data received from another seismic station 1609 at a remote geographic location can be used, in whole or in part, to determine if recorded seismic data from a first seismic station at the location of interest is accurate, e.g., as steps of a data certification process.

In some embodiments, the process 1700 can include block 1702 having steps of receiving a seismic signal from a seismometer. In some embodiments, receiving step 1702 can receive a seismic signal in any suitable format. For example, the step 1702 can receive an electrical signal from the seismometer 1502 at the seismic station 1609. The electrical signal received from the seismometer 1502 can be an analog signal or a digital signal. In some embodiments, the seismic signals can correspond to seismic P-waves, S-waves, and/or the frequency and/or the magnitude of such seismic waves detected by the seismometer 1502. In some embodiments, the seismometer signal can be a continuous reading. In some other embodiments, the seismometer signal can be an instantaneous reading or a plurality of instantaneous readings.

In some embodiments, the process 1700 can include block 1704 having steps of receiving an acceleration signal from an accelerometer. In some embodiments, receiving step 1704 can receive an acceleration signal in any suitable format. For example, the step 1704 can receive an electrical signal from the accelerometer 1504 at the seismic station 1609. The electrical signal received from the accelerometer 1504 can be an analog signal or a digital signal. In some embodiments, the acceleration signal received from the accelerometer 1504 can correspond to axial and/or rotational accelerations around one or more axes, and/or the frequency and/or the magnitude of such accelerations. In other embodiments, the acceleration signals received from the accelerometer 1504 can correspond to axial and/or rotational accelerations of the ground or a structure at the geographic location of interest, and/or the frequency and/or the magnitude of such accelerations. In some embodiments, the acceleration signal can be a continuous reading. In some other embodiments, the acceleration signal can be an instantaneous reading or a plurality of instantaneous readings.

In some embodiments of the process 1700, the steps of block 1702 are absent and only the steps of block 1704 are present. In other embodiments of the process 1700, the steps of block 1704 are absent and only the steps of block 1702 are present. In still other embodiments of the process 1700, the steps of both block 1702 and 1704 are present. When the steps of both blocks 1702 and 1704 are present, the steps of block 1702 can be performed before the steps of block 1704, the steps of block 1704 can be performed before the steps of block 1702, or the steps can be performed simultaneously.

In some embodiments, the process 1700 can include a block 1706 having steps wherein the received seismic signal and/or the received acceleration signal are converted to seismic data. In the illustrated embodiment, the steps of block 1706 follow the steps of both blocks 1702 and 1704. In other embodiments, the steps of block 1706 can be divided into analogous blocks 1706′ and 1706″, wherein the steps of block 1706′ (converting seismic signals to first seismic data) can follow the steps of block 1702 and the steps of block 1706″ (converting acceleration signals to second seismic data) can follow the steps of block 1704. In some embodiments, the converting step 1706 can convert the seismic signal and/or the acceleration signal to seismic data using any suitable technique or combination of techniques and any suitable information. In some embodiments, the process 1700 can covert a first type of seismic signal, e.g., ground accelerations signals, into a second type of seismic signal or seismic data, e.g., ground velocity signals or ground velocity data, using known relationships between acceleration and velocity.

In some embodiments, the process 1700 can convert a seismic signal (or a plurality of seismic signals) received, e.g., from the seismometer 1502, over a predetermined period of time to an average seismic signal. For example, the process 1700 can receive (e.g., in block 1702) a seismic signal or signals relating to seismic wave frequency over a thirty second period, a one minute period or any other suitable amount of time and convert (e.g., in block 1706) the seismic signals or signals over that period to an average seismic wave frequency value. Similar steps can be used to determine an average value for seismic signals corresponding to other effects of seismic waves including, but not limited to, a magnitude or intensity of a seismic event. In other embodiments, the process 1700 can convert an acceleration signal (or a plurality of acceleration signals) received, e.g., from the accelerometer 1504, over a predetermined period of time to an average acceleration signal. For another example, the process 1700 can receive (e.g., in block 1704) an acceleration signal or signals over a thirty second period, a one minute period or any other suitable amount of time and convert (e.g., in block 1706) the acceleration signals or signals over that period to an average acceleration value. Similar steps can be used to determine an average value for other quantities that can be derived from acceleration signals including, but not limited to, average velocity values. Thus, in some embodiments, the blocks 1702 or 1704 can further include steps of storing multiple seismic or acceleration signals received at intervals over a predetermined period of time.

In some embodiments, the steps of block 1706 can include steps of converting seismic signals over a first predetermined period of time to a maximum seismic value during a second, shorter, predetermined time period that is within the first predetermined period of time (referred to sometimes herein as a “peak” seismic value). For example, if the received seismic signals in block 1702 are signals proportional to seismic intensity, the block 1706 can include determining the seismic intensity over a ten-minute base period, and calculating a moving average of the seismic intensity over each three-second period, and finding a maximum three-second average seismic intensity by applying a predetermined multiplier to the maximum three-second moving average seismic intensity. In other embodiments, any values for the first predetermined time period (i.e., “the base period”) and the second predetermined time period (i.e., “the moving average period”) can be used.

Similarly, in other embodiments, the steps of block 1706 can include steps of converting acceleration signals over a first predetermined period of time to a maximum acceleration value during a second, shorter, predetermined time period that is within the first predetermined period of time (referred to sometimes herein as a “peak” acceleration value). For example, if the received acceleration signals in block 1704 are signals proportional to ground acceleration, the block 1706 can include determining the ground acceleration over a ten-minute base period, and calculating a moving average of the ground acceleration over each three-second period, and finding a maximum three-second average ground acceleration by applying a predetermined multiplier to the maximum three-second moving average ground acceleration. In other embodiments, any values for the first predetermined time period (i.e., “the base period”) and the second predetermined time period (i.e., “the moving average period”) can be used.

In some embodiments, the process 1700 can include a block 1708 having steps of determining whether the value corresponding to the received seismic data (i.e., the “measured value”) is higher than a predetermined threshold value. In some embodiments, the received seismic data may be direct measured values, e.g., seismic intensity values or ground acceleration values. In other embodiments, the received seismic data may be calculated seismic values derived from the direct measured values, e.g., ground acceleration values, and/or peak or average values of any such received data. In some embodiments, the block 1708 follows block 1706. For example, if the steps in block 1706 convert the seismic signals to a peak measured seismic intensity value, the steps in block 1708 can determine whether the peak measured seismic intensity value exceeds a predetermined threshold peak seismic intensity value. As another example, if the steps in block 1706 convert the seismic signals to a measured average seismic intensity value, the steps in block 1708 can determine whether the measured average seismic intensity value exceeds a predetermined threshold average seismic intensity value.

Similarly, in some other embodiments, the process 1700 can include a block 1708 having steps of determining whether the value corresponding to the received acceleration data (i.e., the “measured value”) is higher than a predetermined threshold value. In some embodiments, the block 1708 follows block 1706. For example, if the steps in block 1706 convert the acceleration signals to a peak measured acceleration value, the steps in block 1708 can determine whether the peak measured acceleration value exceeds a predetermined threshold peak acceleration value. As another example, if the steps in block 1706 convert the acceleration signals to a measured average acceleration value, the steps in block 1708 can determine whether the measured average acceleration value exceeds a predetermined threshold average acceleration value.

Further, in yet other embodiments, the process 1700 can include a block 1708 having steps of determining whether the value corresponding to the received velocity data (i.e., the “measured value”) is higher than a predetermined threshold value. In some embodiments, the block 1708 follows block 1706. For example, if the steps in block 1706 convert the velocity signals (or the original acceleration signals) to a peak measured velocity value, the steps in block 1708 can determine whether the peak measured velocity value exceeds a predetermined threshold peak velocity value. As another example, if the steps in block 1706 convert the velocity signals (or the original acceleration signals) to a measured average velocity value, the steps in block 1708 can determine whether the measured average velocity value exceeds a predetermined threshold average velocity value.

In some embodiments of the process 1700, in the event that the seismic value (e.g., the measured seismic value, measured average seismic value or measured peak seismic value) or acceleration value (e.g., the measured acceleration value, measured average acceleration value or measured peak acceleration value) or velocity value (e.g., the measured velocity value, measured average velocity value or peak measured velocity value) exceeds a predetermined threshold value, the steps in block 1708 can proceed (as denoted by arrow 1710 in FIG. 17) to block 1712 including steps of sending an alert to be sent to a user device 1604. In some embodiments, steps of block 1712 can cause an alert to be sent to a user device 1604 using any technique or combination of techniques. For example, if the user device 1604 is a mobile phone, the steps of block 1712 can cause a text message to be sent to the user device. As another example, if the user device 1604 is a personal computer, the steps of block 1712 can send an alert via e-mail. As yet another example, the steps of block 1712 can cause an alert to be posted to a Web site.

In some embodiments, the steps of block 1712 can send an alert to a user device 1604 using any suitable communication network. For example, the steps of block 1712 can send an alert using the communication network 316 shown in FIGS. 15 and 16 and described in connection with the hardware 1500 and 1600.

In some embodiments, the process 1700 includes a block 1716 having steps of storing seismic data (including acceleration data and/or velocity data, if applicable) in local memory. In some embodiments, the steps of block 1716 can either follow the steps of block 1708 directly (as denoted by arrow 1714 in FIG. 17) or via the steps of block 1712 (as denoted by arrows 1710 and 1718 in FIG. 17). In some embodiments, any suitable local memory can be used. For example, the steps of block 1716 can store seismic data in the local memory 1508 as shown in FIG. 15 and described in connection with seismic station system 1500.

In some embodiments, the steps of block 1716 can store seismic data in local memory (e.g., memory 1508) in any suitable format. For example, the steps of block 1716 can store the wind speed data in an XML, format, JSON format, CSV format, and/or any other suitable data format.

In some embodiments, the steps of block 1716 can store various quantities of seismic data in local memory. For example, in some embodiments the steps of block 1716 can store days, months, or years of seismic data in local memory. In some embodiments, if the amount of stored seismic data reaches the capacity of a local memory (e.g., memory 1508), a processor (e.g., processor 1506) can continue to store new seismic data by overwriting the oldest previously stored seismic data. In other embodiments, if the amount of seismic data stored in the local memory reaches a predetermined fraction of the total capacity of the local memory, a processor can send a message to a user device 1604 or other device over the communication network 316.

In some embodiments, the process 1700 includes a block 1720 having steps of sending seismic data to a data server. In some embodiments, the steps of block 1720 follow the steps of block 1716. In some embodiments, the steps of block 1720 can send seismic data to a data server using any suitable communication network. For example, the steps of block 1720 can send seismic data to a data server 1602 using the communication network 316 shown in FIGS. 15 and 16 and described in connection with the hardware 1500 and 1600.

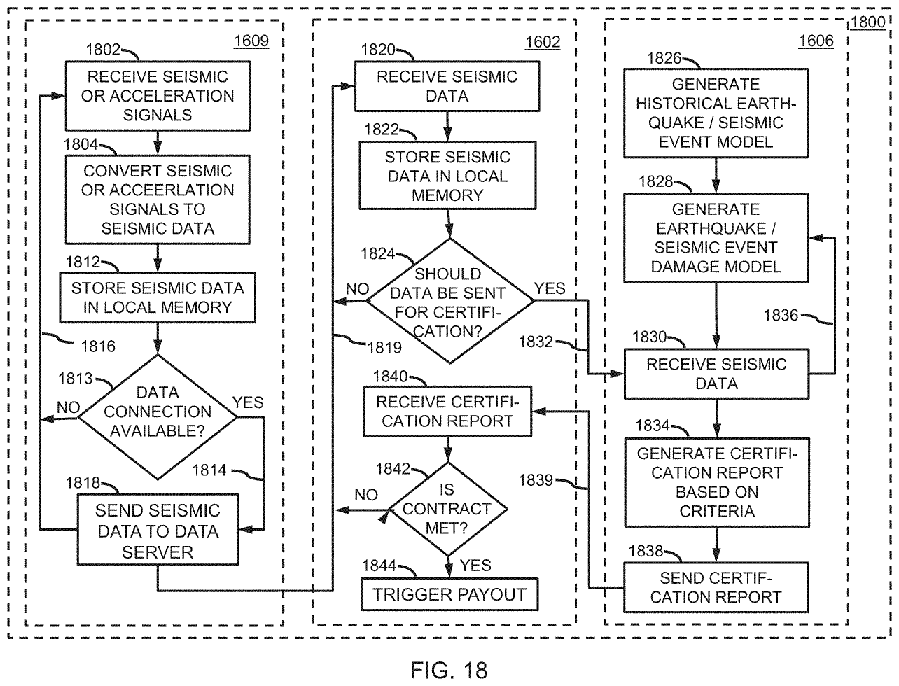

Referring now to FIG. 18, there is illustrated an example of a process 1800 for triggering seismic event payouts based on seismic data in accordance with some embodiments of the disclosed subject matter. In FIG. 18, the example process 1800 is illustrated by means of a block diagram wherein each block represents a step or steps of the process. In some embodiments, additional blocks can be present in between and/or in series with and/or in parallel with the blocks illustrated and/or additional steps can be present between and/or in series with and/or in parallel with the steps described.

In some embodiments, the triggering process 1800 can be executed by any device or combination of devices. For example, the process 1800 can be executed at least in part by one or more data servers (e.g. the data server 1602 of FIG. 16), one or more user devices (e.g., the user device 1604 of FIG. 16), one or more seismic stations (e.g., the seismic station 1609 of FIG. 16 and/or seismic station system 1500 of FIG. 15), one or more certification servers (e.g., the certification server 1606 of FIG. 16), and/or any other suitable device.

In some embodiments, the trigging process 1800 can begin at a block 1802 having steps of receiving a seismic signal or an acceleration signal indicative of a seismic event at a seismic station 1609. In some embodiments, the steps of block 1802 can receive the seismic signal or the acceleration signal using any suitable techniques or combination of techniques. For example, the steps of block 1802 can receive the seismic signal or the acceleration signal as described above for block 1702 and/or block 1704, with reference to FIG. 17.

In some embodiments, the triggering process 1800 includes a block 1804 having steps of converting an seismic signal and/or an acceleration signal into seismic data. In some embodiments, the steps of block 1804 follow the steps of block 1802. In some embodiments, the steps of block 1804 can convert a seismic signal into seismic data using any suitable techniques or combination of techniques and any suitable information. For example, the steps of block 1804 can convert a seismometer or accelerometer signal into seismic data as described above for block 1706 with reference to FIG. 17.

In some embodiments, the triggering process 1800 includes a block 1812 having steps of storing seismic data in a local memory of a seismic station 1609. In some embodiments, the steps of block 1812 follow the steps of block 1804. In some embodiments, the steps of block 1812 can store seismic data in a local memory of a seismic station 1609 using any suitable techniques or combination of techniques. For example, the steps of block 1812 can store seismic data in the local memory of a seismic station 1609 as described above for block 1716 with reference to FIG. 17, or in the local memory 1508 of a seismic station system 1500 as described above with reference to FIG. 15.

In some embodiments, the triggering process 1800 includes a block 1813 having steps of determining whether a data connection is available. In some embodiments, the steps of block 1813 can follow the steps of block 1812. The steps of block 1813 can determine whether a data connection is available using any suitable techniques or combination of techniques and any suitable information. For example, the steps of block 1813 can determine whether a data connection is available by pinging a server, sending a test data packet, querying a server and/or any other suitable technique or combination of techniques.

If the steps of block 1813 determine that a data connection is available, the process 1800 can continue to block 1818 (as denoted by arrow 1814 in FIG. 18) having steps of sending seismic data to a server (e.g., 1602 or 1606). In some embodiments, the steps of block 1818 can send seismic data to a server (e.g., 1602 or 1606) using any suitable techniques or combination of techniques. For example, the steps of block 1818 can send seismic data to a server (e.g., the data server 1602 and/or certification server 1606 of FIG. 16) as described above for block 1720 with reference to FIG. 17. If the steps of block 1813 determine that a data connection is not available, the process 1800 can continue by repeating an earlier part of the process (e.g., as denoted by arrow 1816 in FIG. 18).

In some embodiments, the triggering process 1800 includes a block 1820 having steps of receiving seismic data at a data server (e.g., the data server 1602 of FIG. 16). In some embodiments, the steps of block 1820 follow the steps of block 1818 (as denoted by arrow 1819 in FIG. 18). In some embodiments, the steps of block 1820 can receive seismic data using any suitable techniques or combination of techniques. For example, the steps of block 1820 can receive the seismic data via a communication network (e.g., the communication network 316 of FIGS. 15 and 16).

In some embodiments, the triggering process 1800 includes a block 1822 having steps of storing seismic data. In some embodiments, the steps of block 1822 follow the steps of block 1820. In some embodiments, the steps of block 1822 can store seismic data using any suitable techniques or combination of techniques. For example, the steps of block 1822 can store seismic data on a memory and/or storage (e.g., the memory and/or storage 404 of FIG. 4).

In some embodiments, the triggering process 1800 includes a block 1824 having steps of determining whether seismic data should be sent for certification. In some embodiments, the steps of block 1824 can follow the steps of block 1822. In some embodiments, the steps of block 1824 can determine whether seismic data should be sent for certification using any suitable techniques or combination of techniques and any suitable information. For example, the steps of block 1824 can determine whether seismic data should be sent for certification based on whether the seismic data is related to a well-known seismic event (e.g., a nationally publicized seismic event). As a more particular example, if the seismic data is gathered from a location and time period associated with an earthquake or seismic event reported by a national seismic or geological organization (e.g., the United Stated Geological Survey “USGS”) or national emergency organization (e.g., the Federal Emergency Management Agency “FEMA”), the steps of block 1824 can determine that the seismic data should be sent for certification. As another example, the steps of block 1824 can determine whether seismic data should be sent for certification based on a threshold seismic value. As a more particular example, if the seismic data includes a seismic intensity value that is higher than a predetermined threshold seismic intensity value, the steps of block 1824 can determine that the seismic data should be sent for certification. Similarly, if the seismic data includes a ground acceleration value that is higher than a predetermined threshold ground acceleration value, the steps of block 1824 can determine that the seismic data should be sent for certification. Similarly, if the seismic data includes a ground velocity value that is higher than a predetermined threshold ground velocity value, the steps of block 1824 can determine that the seismic data should be sent for certification. If the steps of block 1824 determine that the seismic data does not need to be certified, the process 1800 can continue by repeating an earlier part of the process (e.g., as denoted by arrow 1819 in FIG. 18).

In some embodiments, the triggering process 1800 includes a block 1826 having steps of generating a historical earthquake or seismic event model. In some embodiments, the steps of block 1826 can generate a historical earthquake or seismic event model using any suitable technique or combination of techniques and any suitable information.

In some embodiments, the steps of block 1826 can generate a historical earthquake or seismic event model using any suitable earthquake or seismic event data. For example, the steps of block 1826 can use data cataloging seismic characteristics of well-known historical earthquakes including, but not limited to, the 1906 San Francisco earthquake, the 1923 Great Kanto earthquake (Japan), the 1964 Alaska earthquake, the 1980 Campania (Italy) earthquake, the 1994 Northridge (California) earthquake and the 2017 Mexico City earthquake. In another example, the steps of block 1826 can catalog the frequency and severity (e.g., overall magnitude, local intensity, local acceleration, etc.) of earthquakes along the San Andreas Fault of southern California over a certain period. As a more particular example, the steps of block 1826 can use an earthquake or seismic event dataset that records the time, date, epicenter location, magnitude, duration, maximum intensity and maximum acceleration for earthquakes from a given set of years, e.g., the years 1900 through 2000. In other embodiments, the steps of block 1826 can use a earthquake or seismic event dataset for earthquake or seismic event from the year 1900 through the most recent year for which earthquake or seismic event data is available. In still other embodiments, the steps of block 1826 can use a earthquake or seismic event dataset for earthquake or seismic event from a predetermined first year agreed-to under a contract through a predetermined final year agreed-to under the contract.

In some embodiments, the steps of block 1826 can further include supplementing historical earthquake or seismic event data by generating synthetic earthquakes or seismic events and/or generating a historical earthquake or seismic event model based at least in part on the synthetic earthquakes or seismic events.

In some embodiments, the triggering process 1800 includes a block 1828 having steps of generating an earthquake or seismic event damage model based on a historical earthquake or seismic event model. In some embodiments, the steps of block 1828 can follow the steps of block 1826, and the historical earthquake or seismic event model can be the historical earthquake or seismic event model generated by the steps of block 1826. In some embodiments, the steps of block 1828 can generate an earthquake or seismic event damage model based on the historical earthquake or seismic event model using any suitable techniques or combination of techniques and any suitable information.

In some embodiments, the steps of block 1828 can generate an earthquake or seismic event damage model by simulating seismic intensity and/or ground accelerations and/or ground velocity based on the historical earthquake or seismic event model. For example, the steps of block 1828 can simulate peak seismic intensity, peak ground acceleration, peak ground velocity or other peak seismic characteristic in the historical earthquake or seismic event model and associate the simulated peak seismic intensity or peak ground acceleration or other peak seismic characteristic with historical damage information.

In some embodiments, the triggering process 1800 includes a block 1830 having steps of receiving seismic data if the process determines (e.g., from the steps of block 1824) that that seismic data should be sent for certification (i.e., as denoted by arrow 1832 in FIG. 18). In some embodiments, the steps of block 1830 can receive seismic data using any suitable technique or combination of techniques. For example, the steps of block 1830 can receive seismic data via a communication network (e.g., the communication network 316 of FIGS. 15 and 16) from a seismic station 1609 or seismic station system 1500 as described above. As another example, the steps of block 1830 can receive seismic data via a communication network (e.g., the communication network 316 of FIGS. 15 and 16) from a data server, e.g., the data server 1602 of FIG. 16. The seismic data received can be seismic data from a seismic station at the geographic location of interest and can also include seismic data from other geographic locations such as remote seismic stations.

In some embodiments, the triggering process 1800 includes a block 1834 having steps of generating a certification report for the received seismic data from the geographic location of interest based on the historical earthquake or seismic event model, and/or the earthquake or seismic event damage model. In some embodiments, the steps of block 1834 can follow the steps of block 1830. In some embodiments, the steps of block 1834 can generate a certification report for the received seismic data from the geographic location of interest based on the historical earthquake or seismic event model (e.g., from block 1826) and/or the earthquake or seismic event damage model (e.g., from block 1828) using any suitable technique or combination of techniques and any additional suitable information. For example, in some embodiments, the process 1800 and the steps of block 1834 can generate a certification report by inputting (as denoted by arrow 1836 in FIG. 18) the received seismic data in addition to information related to buildings in an area related to the seismic data (e.g., construction class of the buildings, building height, building occupancy, year of construction, and/or floor area) into the earthquake or seismic event damage model. As a more particular example, if the seismic characteristics (e.g., seismic intensity or acceleration or velocity) from the seismic data are within a predetermined number of standard deviations from the seismic characteristics of an earthquake or seismic event predicted by the model, the steps of block 1834 can generate a certification report that certifies the seismic data. As another example, the steps of block 1834 can generate a certification report by comparing the received seismic data (e.g., from block 1830) with a seismic intensity predicted by the historical earthquake or seismic event model (e.g., from block 1826). As still another example, the steps of block 1834 can generate a certification report for the seismic data received from the geographic location of interest (i.e., “local seismic data”) by comparing the local seismic data to seismic data received from seismic stations 1609 at other geographic locations for the same event (i.e., “remote seismic data”), and determining if the seismic characteristics of the local seismic data bear a predetermined relationship with the seismic characteristics of the remote seismic data. Such predetermined relationships can be set by review of historic earthquake intensity data, historic earthquake damage data, earthquake intensity models and/or earthquake damage models for the location of interest and the location of the remote seismic station. In some embodiments, first seismic data considered to be local seismic data from a first seismic station 1609 to be certified in a first case can be considered, in a second case, to be remote seismic data from a remote seismic station and used to certify second seismic data from the a second seismic station. As yet another example, the steps of block 1834 can generate a certification report based on earthquake or seismic event data received from a third party server 1614, e.g., from USGS or FEMA.

In some embodiments, the triggering process 1800 includes a block 1838 having steps of sending a certification report (e.g., as denoted by arrow 1839 in FIG. 18). In some embodiments, the steps of block 1838 can follow the steps of block 1834. In some embodiments, the steps of block 1838 can send the certification report using any suitable techniques or combination of techniques. For example, the steps of block 1838 can send the certification report to a data server (e.g., the data server 1602 of FIG. 16) via a communication network (e.g., the communication network 316 of FIG. 16). The triggering process 1800 may further include a block 1840 having steps of receiving the certification report sent by the steps of block 1838. In some embodiments, the steps of block 1840 can receive the certification report using any suitable techniques or combination of techniques. For example, the steps of block 1840 can receive the certification report from a communication network (e.g., the communication network 316 of FIG. 16) using a data server (e.g., the data server 1602 of FIG. 16).

In some embodiments, the triggering process 1800 includes a block 1842 having steps of determining if a contract has been met. In some embodiments, the steps of block 1842 can follow the steps of block 1840. In some embodiments, the steps of block 1842 can determine if a contract has been met using any suitable techniques or combination of techniques and/or any suitable information. For example, the steps of block 1842 can determine if a contract has been met based on the received certification report, e.g., the certification report received from block 1840. For example, the steps of block 1842 can determine that a seismic intensity or a ground acceleration or other seismic characteristic contained in seismic data is greater than a threshold amount contained in a contract and that the certification report certifies that such seismic intensity or ground acceleration or other seismic characteristic is correct, and accordingly determine that the contract has been met. As another example, the steps of block 1842 can determine that a seismic intensity or ground acceleration or other seismic characteristic contained in seismic data is greater than a threshold amount contained in a contract, and that the certification report does not certify that such a seismic intensity or ground acceleration or other seismic characteristic is correct, and accordingly determine that the contract has not been met.

In some embodiments, the steps of block 1842 can determine if a contract has been met by submitting the seismic data and certification report for manual review. For example, if the steps of block 1842 determine that seismic data includes a seismic intensity, ground acceleration, ground velocity or other seismic characteristic that is higher than a respective threshold seismic intensity, ground acceleration, ground velocity or other seismic characteristic contained in a contract, and that the certification report certifies that the seismic data is correct, the steps of block 1842 can then submit the seismic data and the certification report for manual review.

In some embodiments, the triggering process 1800 includes a block 1844 having the steps of triggering a payout of a contract. In some embodiments, the steps of block 1844 can follow the steps of block 1842 if the steps of block 1842 determined that the contract was met. In some embodiments, the steps of block 1842 can trigger a payout of the contract using any suitable technique or combination of techniques. For example, the steps of block 1842 can trigger a payout of the contract by sending information to a contract payout server (e.g., the contract payout server 1608 of FIG. 16). As another example, the steps of block 1842 can trigger a payout by processing an electronic transaction such as a bank deposit, an electronic funds transfer, a direct deposit, sending a digital currency and/or any other suitable electronic transaction.

In some embodiments, at least some of the above-described blocks and/or steps of the processes of FIGS. 17 and 18 can be executed or performed in any order or sequence not limited to the order and sequence shown in and described in connection with the figures. Also, some of the above blocks and/or steps of FIGS. 17 and 18 can be executed or performed substantially simultaneously where appropriate or in parallel to reduce latency and processing times. Additionally or alternatively, some of the above described blocks and/or steps of the processes of FIGS. 17 and 18 can be omitted.

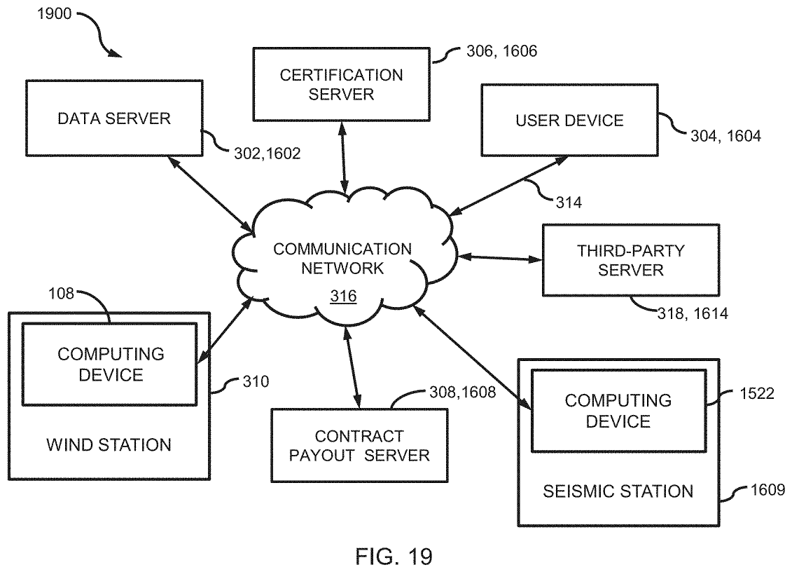

Referring now to FIG. 19, there is illustrated a system 1900 for managing both wind speed data and seismic data that can be used in accordance with some embodiments of the disclosed subject matter. In one embodiment of system 1900, wind speed signals from anemometers 104 at wind station systems 100 and/or wind stations 310 are converted into wind speed data and seismic and/or acceleration signals from seismometers 1502 and/or accelerometers 1504 are converted into seismic signals at seismic station systems 1500 and/or seismic stations 1609. In this embodiment of the system 1900, the respective wind speed data and seismic data can be transmitted through a common communication network 316 to data servers 306, 1602, certification servers 306, 1606 and contract payout servers 308, 1608, wherein the data servers 302 and 1602 can be implemented with the same or separate apparatus, the certification servers 306 and 1606 can be implemented with the same or separate apparatus and/or the contract payout servers 308 and 1608 can be implemented with the same or separate apparatus.

Using the system 1900, a process is provided for triggering multi-factor event payouts based on either wind speed data or seismic data or both types of data in accordance with further embodiments of the disclosed subject matter. Analogous in most respects to the process 1800 of FIG. 18, the multi-factor event triggering process can receive multi-factor data including wind speed data, e.g., from wind stations 310, and seismic data, e.g., from seismic stations 1609. In some embodiments of the multi-factor triggering process, the multi-factor data can be received and stored at a data server 302, 1602 according to processes substantially identical to those described for blocks 1820 and 1822. In some embodiments of the multi-factor triggering process, the data server 302, 1602 can determine if the multi-factor data should be sent for certification according to processes substantially identical to those described for block 1824. When sent for certification, the multi-factor data can be received by a certification server 306, 1606. In some embodiments of the multi-factor triggering process, the certification server 306, 1606 can generate historical storm models, wind speed damage models, historical earthquake or seismic event models and earthquake or seismic event damage models according to processes substantially similar to those described for blocks 1826 and 1828.

In some embodiments, the multi-factor triggering process can further have steps of receiving multi-factor data if the process determines (e.g., from the steps of block 1824) that that multi-factor data should be sent for certification (i.e., as denoted by arrow 1832 in FIG. 18). The steps of receiving the multi-factor data can be substantially similar to the processes described for block 1830. In some embodiments of the multi-factor triggering process, a certification report can be generated for the received multi-factor data according to processes substantially similar to those described for block 1834. In some embodiments of the multi-factor triggering process, a certification report can be sent (e.g., to a data server 302 or 1602) via a communication network according to processes substantially similar to those described for block 1838. In some embodiments, the multi-factor triggering process can receive the certification report using any suitable techniques or combination of techniques. For example, the certification report can be received from a communication network (e.g., the communication network 316) using a data server (e.g., the data server 302 or 1602).

In some embodiments, the multi-factor triggering process includes steps of determining if a contract has been met according to processes substantially similar to those described for block 1842. In some embodiments, the multi-factor triggering process can determine if a contract has been met using any suitable techniques or combination of techniques and/or any suitable information. For example, the steps can determine if a contract has been met based on the received certification report covering wind speed data and/or seismic data. For example, the steps of the multi-factor process can determine that a measured wind speed value contained in wind speed data is greater than a threshold value contained in a contract and that the certification report certifies that such measured wind speed value is correct, and/or that a measured seismic intensity value, a measured ground acceleration value or a measured ground velocity value contained in seismic data is greater than a respective threshold value contained in a contract and that the certification report certifies that such respective measured seismic intensity value, measured ground acceleration value, or measured ground velocity value is correct, and thereupon determine that the contract has been met. In some embodiments, a certification report can certify that a respective measured wind or seismic value is “correct” if the respective measured value falls within predetermined parameters compared to one or more certification control values specified in the contract. In some embodiments, the respective certification control values can be respective wind or seismic values predicted by a respective wind or seismic historical model or wind or seismic damage model. In some other embodiments, the respective certification control values can be respective wind or seismic values received from one or more predetermined remote wind or remote seismic stations. In one example, the predetermined parameters can be a predetermined number of standard deviations, i.e., the measured values are considered “correct” if they are within a predetermined number of standard deviations from the control values, e.g., from the values predicted by the historical model or damage model or received from the remote station. In another example, the predetermined parameters can be a predetermined percentage difference, i.e., the measured values are considered “correct” if they are within a predetermined percentage difference from the control values, e.g., from the values predicted by the historical model or damage model or received from the remote station. However, even if a measured wind speed, seismic intensity, ground acceleration or ground velocity contained, respectively, in a wind speed data or seismic data is greater than a threshold amount contained in a contract, the steps of the multi-factor triggering process can determine that a contract is not met if the certification report does not certify that such a measured wind speed, seismic intensity, ground acceleration or ground velocity is correct.

In some embodiments, the steps of the multi-factor triggering process can determine if a contract has been met by submitting the wind data and seismic data and certification report for manual review. For example, if the earlier steps determine that wind data includes a wind speed that is higher than a threshold wind speed contained in a contract, or the earlier steps determine that seismic data includes a seismic intensity or ground acceleration that is higher than a threshold seismic intensity or ground acceleration contained in the contract, and that the certification report certifies that the relevant wind data and/or seismic data is correct, the steps of the triggering process can then submit the wind speed data and the seismic data and the certification report for manual review.

In some embodiments, the multi-factor triggering process includes the steps of triggering a payout of a contract according to processes substantially similar to those described for block 1844. In some embodiments, the steps of triggering a payout of a contract can follow the steps of determining that the contract was met. In some embodiments, the steps can trigger a payout of the contract using any suitable technique or combination of techniques. For example, the steps of the multi-factor triggering process can trigger a payout of the contract by sending information to a contract payout server (e.g., the contract payout server 308 or 1608). As another example, the steps of the multi-factor triggering process can trigger a payout by processing an electronic transaction such as a bank deposit, an electronic funds transfer, a direct deposit, sending a digital currency and/or any other suitable electronic transaction. In some embodiments, if two separate contract criteria are satisfied by certified data, the multifactor triggering process can trigger two separate payouts, i.e., one payout for each criterion satisfied. In other embodiments, if two separate contract criteria are satisfied by certified data, the multifactor triggering process can trigger only the higher one of the two separate payouts (e.g., if the payout amounts for the two criteria are different), or only a single payout (e.g., if the payout amounts are for the two criteria are identical).

In still another aspect, secure measurement stations can be provided at particular geographic locations to measure other natural and/or manmade phenomena events including, but not limited to, tsunami or tidal waves, volcanic ash or gas emissions, droughts, air pollution (also known as “smog”) levels or levels of specific pollutants at the particular geographic locations, wherein the various phenomena event measurements are received and converted into phenomena event data and stored in memory in the secure measurement stations using apparatus and processes analogous to those described herein for wind speed and seismic data. Further, the phenomena event data from the secure measurement stations can be transmitted to a phenomena event data system including data servers, certification servers and/or payout servers using apparatus and processes analogous to those described herein for wind speed and seismic data. The phenomena event data system can provide apparatus and processes for receiving the phenomena event data analogous to those described herein for wind speed and seismic data and determining if the event data needs to be certified. The phenomena data system can provide apparatus and processes for generating historical models of various phenomena events and/or for generating damage models of various phenomena events analogous to those described herein for wind speed and seismic data. The phenomena data system can provide apparatus and processes for triggering payouts triggering payouts analogous to those described herein for wind speed and seismic data. The phenomena data system can provide apparatus and processes for triggering payouts based on the phenomena data from the secure measurement stations, either alone or combined with wind speed data and/or seismic data from wind stations and/or seismic stations, respectively.

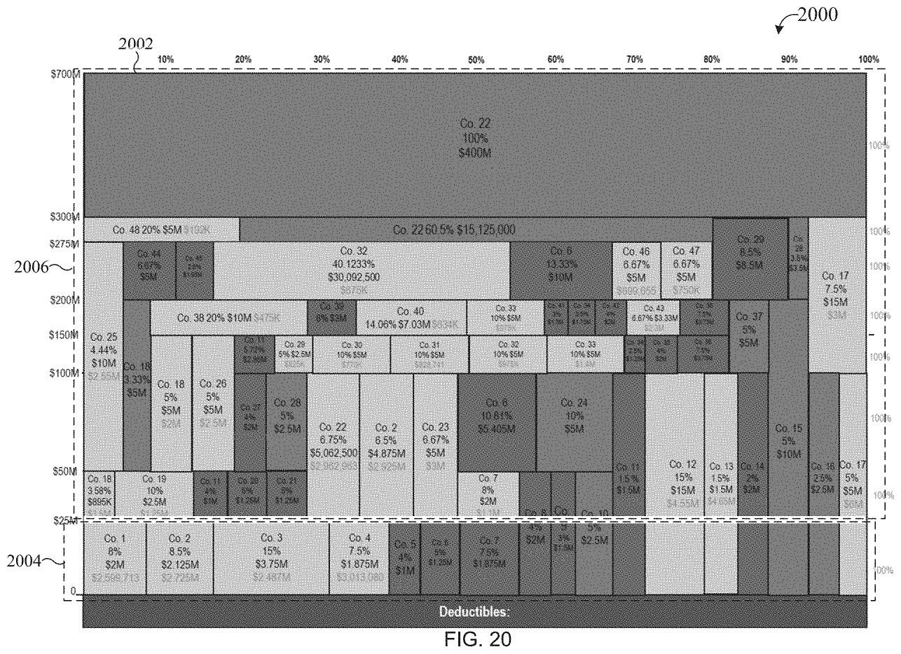

Referring now to FIG. 20, an exemplary coverage chart 2000 is provided for illustrating complex insurance coverage for an entity. For large entities, multiple insurance companies 2002 are utilized to reduce overall risk to a single insurance company 2002. Typically, an entity will negotiate for an amount of coverage that would cover any foreseeable losses in case of an event. A foreseeable loss could include loss of or damage to a building or multiple buildings or other property. Each insurance company can negotiate an amount of coverage, a percentage of coverage, a premium for the coverage and a deductible. The deductible is an amount of money that the entity is required to pay before the insurance begins paying out. The deductible is usually decided by the entity before negotiation begins in order for each insurance company 2002 to determine the specific risk involved with insuring the entity. Therefore, the deductible is normally the same for all companies. In certain embodiments, the deductible can be variable for each of the insurance companies

The amount of coverage and percentage of coverage are used to determine a total coverage for a specific insurance company 2002. For example, company 1 (denoted “Co. 1 in FIG. 20) negotiated to cover eight percent of the first $25 million in damages (after deductible is met). This means that company 1 would have a maximum payout of $2 million when the event causes $25 million in damages. In the case where only $15 million damages (above deductible) were caused to the entity, company 1 would be responsible for $1.2 million in payouts to the entity. The premium received by insurance company number 1 for this position is 8% of approximately $2.6 million. The premium relates to the risk of the position determined by the insurance company.

Referring still to FIG. 20, certain insurance companies can hold positions that are subsequent to other payouts. For example, insurance company 25 (denoted “Co. 25” in FIG. 20) holds a position for 4.44% of $225 million, but only for damages greater than $50 million (after deductible). This means that insurance company 25 does not begin to payout to the entity until $50 million in damages have been determined above the deductible. The payout for insurance company 25 would be 4.44% of every dollar of damage in excess of $50 million over the deductible. When the total damage (after deductible) to the entity is at $275 million or greater, company 25 would pay out $10 million based on this position. Because more damages are required before company 25 has to payout, insurance company 25 has less risk initially and receives a reduced premium rate. A reduced premium rate means that the premium is less as a percentage than the premium that insurance company 1 will receive. However, the amount of coverage by insurance company 25 is greater than the amount of coverage by insurance company 1 (although the percentage of coverage for that amount is less). The premium that insurance company 25 collects for this coverage would be 4.44% of approximately $2.55 million.

In certain embodiments, insurance companies 2002 can hold more than one position in the coverage 2000. In the illustrated embodiment, insurance company 2, insurance company 6, insurance company 7, insurance company 11, insurance company 16, insurance company 18, insurance company 22, insurance company 28, insurance company 29, insurance company 32, insurance company 33, insurance company 34, and insurance company 35 all have multiple positions in coverage 2000. For example, insurance company 2 holds a first position for 8.5% of the first $25 million after the deductible, and a second position for 6.5% of $75 million after the first $25 million. Based on the two positions, company 2 receives, respectively, 8.5% of $2.725 million and 6.5% of $2.925 million and has max liability, respectively, of $2.125 million and $4.875 million

Primary positions 2004 are positions that are the first positions to payout when damages exceed the deductible threshold. A primary position 2004 can be determined based on a lowest amount of coverage, an amount equal to the deductible, an percentage amount compared to the deductible, an agreed upon amount, a percentage of actual damage, a percentage of estimated damage, a percentage of effective damage, or any other suitable amount. The primary positions 2004 are positions that can be negotiated to paying out prior to the deductible in situations where parametric triggers are met. Primary position 2004 can be positions based on an urgency or emergency funding. For example, when a structure is damaged or destroyed, money could be needed to pay down payments for contractors, buy supplies, etc. In the illustrative embodiment, the primary positions 2004 for amounts under $25 million includes a first tier of insurance companies 1-7 and a portion of insurance companies 8-17. The primary positions 2004 can be extend to a second tier or higher tier of insurance companies. For example, the primary positions could be extended to $50 million and further includes insurance companies 18-21, a portion of insurance companies 22-23, a second instance of insurance companies 7 and 11, remaining portions of insurance companies 8-10, and second portions of insurance companies 11-17.

Some insurance companies hold secondary positions 2006 or non-primary positions. Secondary position 2006 can be determined based on a lowest amount of coverage, an amount equal to the deductible, an percentage amount compared to the deductible, an agreed upon amount, a percentage of actual damage, a percentage of estimated damage, a percentage of effective damage, or any other suitable amount. Secondary positions 2006 may or may not have options to pay out prior to the deductible. The secondary positions 2006 can be positions that can cover general or lingering costs that are not as urgent. For example, when a structure is damage or destroyed, money could be need for jobs like electricians, plumbers, painting, etc. that is not needed immediately after a destructive event. In the illustrative embodiment, the secondary positions 2006 can include remaining portions of insurance companies 8-17 and insurance companies 2, 6, 7, and 18-48.

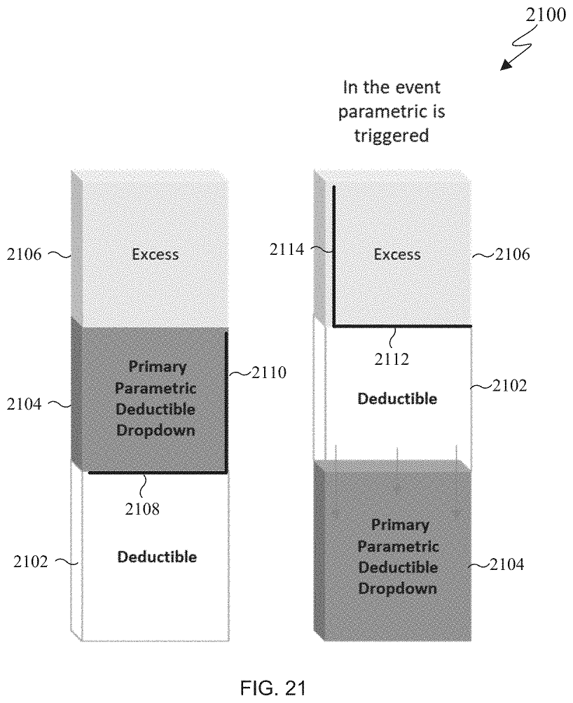

Referring now to FIG. 21, an exemplary drop-down endorsement 2100 is provided for releasing funds from primary position prior to meeting a deductible threshold. After events, an entity might need emergency cash to begin repairs on damaged property, cover lost profits, etc. Waiting for insurance companies to determine damage models for payouts and proof of deductibles met could cause detrimental effect to an insured entity. While a single instance of deductible 2102, primary parametric deductible dropdown 2104, and excess 2106 are illustrated, the instances can represent multiple companies that are defined within each category. (e.g. similar to FIG. 20)

A primary parametric deductible dropdown 2104 involves an entity to be ensured negotiating with an insurance company 2002 to provide a primary position 2004 that has the ability to payout under specific conditions prior to the deductible 2102 being met. In events where parametric triggers are not met, the insurance companies would pay out primary positions after a deductible 2102 has been met.

The primary parametric deductible dropdown 2104 can be defined based on a primary threshold 2108 and a primary max payout 2110. The primary parametric deductible dropdown 2104 can represent any position that an insurance company holds as a primary position 2004. The primary threshold 2108 can initially be an amount of a deductible 2102. The primary threshold 2108 is variable in this embodiment. The primary threshold 2108 can be designed to drop based on a predetermined amount, such as based on a negotiation. The primary threshold 2108 can be lowered any amount, essentially splitting the deductible 2102 into two portions, part before the primary parametric deductible dropdown 2104 and part after the primary parametric deductible dropdown 2104. In the illustrative embodiment (right side of FIG. 21), the primary threshold 2108 is lowered to zero, essentially “switched” with the deductible 2102.

The primary max payout 2110 is a maximum amount of funding that a company would payout. The primary max payout 2110 is normally fixed but may have additional variability factored in based on the parametric event triggered. The primary max payout 2110 defines an amount of money paid to the insured regardless of the value of the primary threshold 2004.

The specific conditions of the primary parametric deductible dropdown 2104 could include ways of determining that a damage amount would likely exceed that primary amount and deductible amount. The primary parametric deductible dropdown 2104 could be based on parametric data measured from an event compared to historic parametric data. For example, the historic parametric data could be used to determine parametric thresholds and the measured parametric data would need to exceed the parametric thresholds. Primary parametric deductible dropdown 2104 could also negotiate a higher premium in relation to the parametric thresholds. For example, the risk of payout is higher when the parametric thresholds are lowered, and the premiums can be adjusted to reflect the higher risk of payout.

The specific conditions can require one or more parametric triggers to be met. A negotiation of the specific conditions for a primary parametric deductible dropdown 2104 include different, separate parametric triggers of a same or different type. For example, the parametric trigger could include multiple wind sensors at different location, where each wind sensor can be related to a separate trigger condition. In some embodiments, the wind sensor could represent a single parametric trigger requiring more than one wind sensor detect a wind speed greater than a wind speed threshold. Also, for example, the multiple parametric triggers could include a wind sensor and tide sensor. If either of the wind speed exceeding a wind speed threshold or the water level exceeding a height threshold, then the primary deductible dropdown 2104 would activate.

Another example of parametric triggers could be related to seismic activity or earthquakes. The parametric triggers could include one or more seismic sensors, including ground acceleration sensors, vibration sensors, etc. The parametric triggers for seismic activity could include multiple seismic sensors each acting as a separate trigger, a group of seismic sensors could act a single sensor where a partial or full amount of the group would active the trigger. Triggers of different types could be used to alternatively confirm seismic activity.

The excess 2106 is paid out after the deductible 2102 and primary parametric deductible dropdown 2104 are met and paid out. The excess 2106 is paid when the damage exceeds the amount of the deductible 2102 and primary parametric deductible dropdown 2104 are covering. The excess 2106 is unaffected by the parametric triggers. The excess 2106 can be defined based on a second threshold and a second max payout.

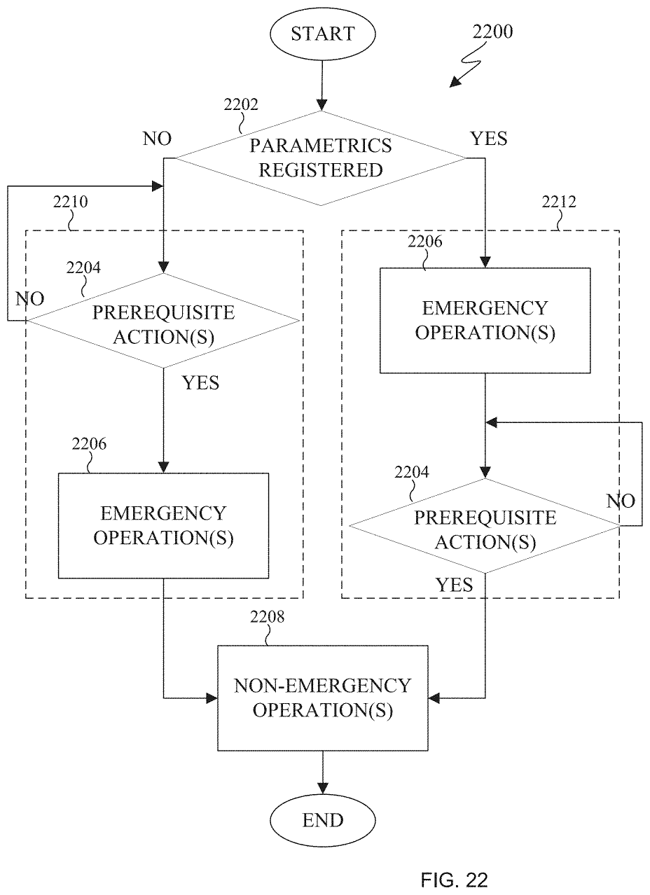

Referring now to FIG. 22, in the illustrated embodiment, a process 2200 is presented for a response to an event. An event can include any type of destructive force. Some events can have predictive components and/or responsive components. For example, a path of a hurricane can typically be identified days in advance.

Process 2200 is dependent on parametric registering in step 2202. The process 2200 further includes a determination of requisite actions in step 2204, emergency operations in step 2206 and non-emergency operations in step 2208. In the process 2200, a determination of the parametric thresholds, prerequisite actions, emergency operations, and non-emergency operations occurs prior to an event.

In step 2202, parametric values are collected and registered. To register the parametric values, the parametric values must exceed a threshold. When the parametric values do not exceed a parametric threshold, the process 2200 proceeds to regular order of operations 2210. When one or more parametric values exceed one or more parametric thresholds, the process 2200 proceeds to parametric registered order of operations 2212. For example, the parametric values could include multiple wind sensors at different location, where each wind sensor can be related to a separate trigger condition. In some embodiments, the wind sensor could represent a single parametric trigger requiring more than one wind sensor detect a wind speed greater than a wind speed threshold. Also, for example, the multiple parametric triggers could include a wind sensor and tide sensor. If either of the wind speed exceeding a wind speed threshold or the water level exceeding a height threshold, then the process 2200 would proceed with parametric registered order of operations 2212.

The thresholds can be determined from historic data that is measured prior to a destructive event occurring. For example, barometric pressure drops could indicate proximity of a hurricane. While hurricanes are slow moving events, determining a proximity could aid emergency workers (such as police, fire, etc.) searching or proceeding to safety at a later time to provide an increased amount of service to a community. Earthquakes move much more quickly and are less likely to be alerted properly before arriving.

Other thresholds can be determined based on historic data that is measured during or after a destructive event has occurred. Parametric measurements could be used to determine destructive force or estimate damage of an event. Damages from previous events can be compared to identify levels of parametric data that appear to form a correlation between the event and the level of parametric data. The correlation could then be used as a threshold for parametric registering.

In step 2204, prerequisite actions are taken in order to confirm an event is predicted to pass or has passed through a region. Prerequisite action could include pulling road information from a public source or identifying road conditions through images taken or roads from a satellite or camera. Prerequisite actions could include using other parametric data that has not been fully conclusive or parametric data used in combination with other factors. Prerequisite actions could includes a system shutting down utilities that could reduce effectiveness of emergency operations and non-emergency operations. Prerequisite actions could include receiving some indication that damage has occurred, is likely to occur, is currently occurring, etc. The indications could include receiving a signal by an electric device communicating with an automated system. Prerequisite actions could include maintaining or receiving funds.

Emergency operations are performed in step 2206. Emergency operations can include operations that are urgent to address for proper recovery from a destructive event. When a system can predict a destructive event before it the occurs, such as a path of a hurricane or a spread of an earth quake, the system can provide alerts to electronic device in the region. Other emergency events could include shutting off gas to a structure that is susceptible to catching fire in a destructive event. Other emergency events could include providing funds after a destructive event to ensure that an entity can reduce downtime for recovery.

Non-emergency operations are performed in step 2208. Non-emergency operations can include operations that are less urgent or a lower priority than the emergency operations. Non-emergency operations can include reestablishing internet or cable connections. Non-emergency operations can also include funding for non-essential services.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A system for collecting and managing multi-trigger parametric data, comprising:
a payout server including:
a payout communication interface operatively coupled to an external communication network and configured to receive invoices;
a payout server computing device configured to process payments;
a payout server memory configured to store a first threshold and a first payout limits;
an accumulator configured to:
track a total amount of the received invoices;
determine that a total amount of the received invoices is greater than the first threshold;
in response to the total amount of the received invoices is determined to be greater than the first threshold, control the payout communication interface to provide the received invoices to the payout server computing device for processing payments;
determine that a total for the processed payments is equal to the first payout limits; and
in response to the total for the processed payments is determined to be equal to the first payout limits, control the payout communication interface to stop providing the received invoices to payout server computing device;
a parametric data station including:
a parametric data sensor configured to produce parametric data signal indicative of a measured parametric data value at a location of the parametric data station;
a station computing device operatively connected to the parametric data sensor and configured receive the parametric data signal and produce parametric data corresponding to the parametric data signal; and
a station communication interface operatively connected to the station computing device and the external communication network, and configured to receive the parametric data from the station computing device and transmit the parametric data to the external communication network; and
a certification server including:
a certification communication interface operatively coupled to the external communication network and configured to receive the parametric data from the parametric data station and transmit a signal for adjusting the first threshold to the payout communication interface;
a certification server memory configured to store parametric thresholds; and
a certification server computing device configured to:
determine that the received parametric data exceeds a parametric threshold; and
in response to the received parametric data exceeding the parametric threshold, generate the signal to cause a reduction of the first threshold.

2. The system of claim 1, wherein an amount of the first threshold is equal to an amount of the first payout limits.

3. The system of claim 1, wherein the payout server memory includes an amount for the reduction prior to receiving the signal from the certification server.

4. The system of claim 1, wherein the first threshold is reduced to zero.

5. The system of claim 1, wherein:
a second threshold is equal to the first payout limits added to the first threshold before the reduction; and
the accumulator is further configured to:
determine that the total amount of the received invoices is greater than the second threshold; and
in response to the total amount of the received invoices is determined to be greater than the second threshold, control the payout communication interface to provide the received invoices to the payout server computing device for processing payment.

6. The system of claim 5, wherein:
the payout communication interface is further configured to receive an externally-processed invoice; and
after the total amount of received invoices has exceed the first threshold, the accumulator is further configured to reduce the second threshold by an amount of the externally-processed invoice.

7. The system of claim 6, wherein, when an amount of the externally-processed invoice reduces the second threshold below a value of the first payout limits, the accumulator is configured to maintain providing payments to the payout server computing device when the total amount of the received invoices is equal to or greater than the first payout limits.

8. The system of claim 1, wherein, to determine that the received parametric data exceeds a parametric threshold and to generate the signal to cause a reduction of the first threshold, the certification server computing device is further configured to:
determine that a first parametric data exceeds a first parametric threshold;
determine that a second parametric data exceeds a second parametric threshold; and
in response to the first parametric data exceeding the first parametric threshold and the second parametric data exceeding the second parametric threshold, generate the signal to cause the reduction of the first threshold.

9. The system of claim 8, wherein the first parametric data is a different parametric type than the second parametric data.

10. The system of claim 8, wherein the first parametric data and the second parametric data are both a parametric data type and are captured from different parametric sensors.

11. A system for collecting and managing multi-trigger parametric data, comprising:
a payout server including:
a payout communication interface operatively coupled to an external communication network and configured to receive invoices;
a payout server computing device configured to process payments;
a payout server memory configured to store a first threshold and a first payout limits;
an accumulator configured to:
track a total amount of the received invoices;
determine that a total amount of the received invoices is greater than the first threshold;
in response to the total amount of the received invoices is determined to be greater than the first threshold, control the payout communication interface to provide the received invoices to the payout server computing device for processing payments;
determine that a total for the processed payments is equal to the first payout limits; and
in response to the total for the processed payments is determined to be equal to the first payout limits, control the payout communication interface to stop providing the received invoices to payout server computing device; and
a certification server including:
a certification communication interface operatively coupled to the external communication network and configured to receive parametric data from a parametric data station and transmit a signal for adjusting the first threshold to the payout communication interface;
a certification server memory configured to store parametric thresholds; and
a certification server computing device configured to:
determine that the received parametric data exceeds a parametric threshold;
in response to the received parametric data exceeding the parametric threshold, generate the signal to cause a reduction of the first threshold.

12. The system of claim 11, wherein an amount of the first threshold is equal to an amount of the first payout limits.

13. The system of claim 11, wherein the payout server memory includes an amount for the reduction prior to receiving the signal from the certification server.

14. The system of claim 11, wherein the first threshold is reduced to zero.

15. The system of claim 11, wherein:
a second threshold is equal to the first payout limits added to the first threshold before the reduction; and
the accumulator is further configured to:
determine that the total amount of the received invoices is greater than the second threshold; and
in response to the total amount of the received invoices is determined to be greater than the second threshold, control the payout communication interface to provide the received invoices to the payout server computing device for processing payment.

16. The system of claim 15, wherein:
the payout communication interface is further configured to receive an externally-processed invoice; and
after the total amount of received invoices has exceed the first threshold, the accumulator is further configured to reduce the second threshold by an amount of the externally-processed invoice.

17. The system of claim 16, wherein, when an amount of the externally-processed invoice reduces the second threshold below a value of the first payout limits, the accumulator is configured to maintain providing payments to the payout server computing device when the total amount of the received invoices is equal to or greater than the first payout limits.

18. The system of claim 11, wherein, to determine that the received parametric data exceeds a parametric threshold and to generate the signal to cause a reduction of the first threshold, the certification server computing device is further configured to:
determine that a first parametric data exceeds a first parametric threshold;
determine that a second parametric data exceeds a second parametric threshold; and
in response to the first parametric data exceeding the first parametric threshold and the second parametric data exceeding the second parametric threshold, generate the signal to cause the reduction of the first threshold.

19. The system of claim 18, wherein the first parametric data is a different parametric type than the second parametric data.

20. The system of claim 18, wherein the first parametric data and the second parametric data are both a parametric data type and are captured from different parametric sensors.
